(19) United States
(12) Patent Application Publication
(10) Pub. No.: US 2020/0074122 A1
(43) Pub. Date: Mar. 5, 2020

(54) CRYPTOGRAPHIC OPERATION PROCESSING METHOD, APPARATUS, AND SYSTEM, AND METHOD FOR BUILDING MEASUREMENT FOR TRUST CHAIN

(71) Applicant: Alibaba Group Holding Limited, Grand Cayman, KY (US)

(72) Inventors: Yingfang Fu, Beijing (CN); Peng Xiao, Hangzhou (CN)

(73) Assignee: Alibaba Group Holding Limited

(21) Appl. No.: 16/554,383

(22) Filed: Aug. 28, 2019

(30) Foreign Application Priority Data
Aug. 29, 2018 (CN) 201810998169.9

(51) Int. Cl. G06F 21/72; H04L 9/08; H04L 9/06; H04L 9/32

(52) U.S. Cl. CPC G06F 21/72; H04L 9/0861; H04L 2209/38; H04L 9/3265; H04L 9/0643

(57) ABSTRACT

A method including receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; receiving, by the cryptographic operation chip, a comparison result fed back by the security chip, wherein the comparison result is a result determined by the security chip and indicating whether the first measurement result is the same as a second measurement result stored in advance; and performing, by the cryptographic operation chip, a cryptographic operation when the comparison result indicates that the first measurement result is the same as the second measurement result. The present disclosure solves the technical problem that cryptographic operation algorithm firmware cannot be measured and consequently the credibility of cryptographic operations is low.

### CROSS REFERENCE TO RELATED PATENT APPLICATIONS

This application claims priority to Chinese Patent Application No. 201810998169.9, filed on 29 Aug. 2018 and entitled “CRYPTOGRAPHIC OPERATION PROCESSING METHOD, APPARATUS, AND SYSTEM, AND METHOD FOR BUILDING MEASUREMENT FOR TRUST CHAIN,” which is incorporated herein by reference in its entirety.

### TECHNICAL FIELD

The present disclosure relates to the field of cryptographic operations, and, more particularly, to cryptographic operation processing methods, apparatuses, and systems, and methods for building measurement for trust chains.

### BACKGROUND

With the popularization of computer applications and increasingly rampant hardware attacks, more attention has been paid to the integrity assurance for transaction platforms and systems. Measurement is a novel technological means for protecting the integrity of platforms and systems as follows: at certain moments, a target is measured to obtain certain information of the target (e.g., hash values of files), the information values are compared with pre-recorded standard values, thereby determining whether the target integrity has been destroyed.

With respect to conventional Trusted Platform Modules (TPMs) and Trusted Platform Control Module (TPCMs), in trusted high-speed encryption card scenarios, existing measurement methods and processes cannot ensure the integrity of a cryptographic operation algorithm during high-speed cryptographic operations. In addition, the conventional techniques cannot ensure the trusted loading and trusted dynamic execution of cryptographic operation firmware during high-speed cryptographic operations, thereby resulting in a low credibility of cryptographic operations.

No effective solution has been proposed currently to solve the above problems.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide cryptographic operation processing methods, apparatuses, and systems, and methods for building measurement for trust chains, to at least solve the technical problem in the conventional techniques that cryptographic operation algorithm firmware cannot be measured and consequently the credibility of cryptographic operations is low.

According to an example embodiment of the present disclosure, a cryptographic operation processing method is provided, including: receiving, by a cryptographic operation chip, a cryptographic operation request; measuring, by the cryptographic operation chip, cryptographic operation algorithm firmware by using a cryptographic operation measurement root to obtain a first measurement result, sending, by the cryptographic operation chip, the obtained first measurement result to a security chip; receiving, by the cryptographic operation chip, a comparison result fed back by the security chip, wherein the comparison result is a result determined by the security chip and indicating whether the first measurement result is the same as a second measurement result stored in advance; and performing, by the cryptographic operation chip, a cryptographic operation when the comparison result indicates that the first measurement result is the same as the second measurement result. In the preset disclosure, for example, measurement root refers to root of trust for measurement.

According to another example embodiment of the present disclosure, a cryptographic operation processing method is further provided, including: receiving, by a security chip, a first measurement result sent by a cryptographic operation chip, wherein the first measurement result is a measurement result obtained through measuring cryptographic operation algorithm firmware by the cryptographic operation chip using a cryptographic operation measurement root; acquiring, by the security chip, a second measurement result stored in advance; and comparing, by the security chip, the first measurement result with the second measurement result to obtain a comparison result indicating whether the first measurement result is the same as the second measurement result, and sending, by the security chip, the comparison result to the cryptographic operation chip, so that the cryptographic operation chip performs a cryptographic operation when the comparison result indicates that the first measurement result is the same as the second measurement result.

According to another example embodiment of the present disclosure, a cryptographic operation processing method is further provided, including: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; acquiring, by the security chip, a second measurement result stored in advance, comparing, by the security chip, whether the first measurement result is the same as the second measurement result to obtain a comparison result, sending, by the security chip, the comparison result to the cryptographic operation chip; and performing, by the cryptographic operation chip, a cryptographic operation when the comparison result indicates that the first measurement result is the same as the second measurement result.

According to another example embodiment of the present disclosure, a method for building a measurement for trust chain is further provided, including: establishing a static measurement for trust chain based on a security chip, wherein the static measurement for trust chain includes a static measurement for trust performed on a measurement target when a system of a device is started; establishing a dynamic measurement for trust chain based on a cryptographic operation chip, wherein the dynamic measurement for trust chain includes a dynamic measurement for trust performed on a measurement target when a measurement for trust request is received; and building a measurement for trust chain based on the established static measurement for trust chain and the established dynamic measurement for trust chain.

According to another example embodiment of the present disclosure, a cryptographic operation processing apparatus is further provided. The cryptographic operation processing apparatus is applied to a cryptographic operation chip and includes: a first receiving module configured to receive a cryptographic operation request; a measurement module configured to measure cryptographic operation algorithm firmware by using a cryptographic operation measurement root to obtain a first measurement result, and send the obtained first measurement result to a security chip; a receiving module configured to receive a comparison result fed back by the security chip, wherein the comparison result is a result determined by the security chip and indicating whether the first measurement result is the same as a second measurement result stored in advance; and an operation module configured to perform a cryptographic operation when the comparison result indicates that the first measurement result is the same as the second measurement result.

According to another example embodiment of the present disclosure, a cryptographic operation processing apparatus is further provided. The cryptographic operation processing apparatus is applied to a security chip and includes: a second receiving module configured to receive a first measurement result sent by a cryptographic operation chip, wherein the first measurement result is a measurement result obtained through measuring cryptographic operation algorithm firmware by the cryptographic operation chip using a cryptographic operation measurement root; an acquiring module configured to acquire a second measurement result stored in advance; and the comparison module configured to compare the first measurement result with the second measurement result to obtain a comparison result indicating whether the first measurement result is the same as the second measurement result, and send the comparison result to the cryptographic operation chip, so that the cryptographic operation chip performs a cryptographic operation when the comparison result indicates that the first measurement result is the same as the second measurement result.

According to another example embodiment of the present disclosure, a cryptographic operation processing system is further provided. The cryptographic operation processing system includes: a cryptographic operation chip and a security chip, wherein the cryptographic operation chip is configured to receive a cryptographic operation request, measure cryptographic operation algorithm firmware by using a cryptographic operation measurement root to obtain a first measurement result, and send the obtained first measurement result to the security chip; and the security chip is configured to acquire a second measurement result stored in advance, compare whether the first measurement result is the same as the second measurement result to obtain a comparison result, and send the comparison result to the cryptographic operation chip; and the cryptographic operation chip is further configured to perform a cryptographic operation when the comparison result indicates that the first measurement result is the same as the second measurement result.

According to another example embodiment of the present disclosure, a system for building a measurement for trust chain is further provided. The system includes: a static measurement for trust chain building subsystem and a dynamic measurement for trust chain building subsystem, wherein the static measurement for trust chain building subsystem is configured to establish a static measurement for trust chain based on a security chip, wherein the static measurement for trust chain includes a static measurement for trust performed on a measurement target when a system of a device is started; the dynamic measurement for trust chain building subsystem is configured to establish a dynamic measurement for trust chain based on a cryptographic operation chip, wherein the dynamic measurement for trust chain includes a dynamic measurement for trust performed on a measurement target when a measurement for trust request is received; and the static measurement for trust chain building subsystem and the dynamic measurement for trust chain building subsystem are further configured to build a measurement for trust chain based on the established static measurement for trust chain and the established dynamic measurement for trust chain.

According to another example embodiment of the present disclosure, a computer storage medium is further provided. The computer storage medium includes a program stored therein, wherein the program, when executed, controls a device in which the computer storage medium resides to perform any one of the above cryptographic operation processing methods.

According to another example embodiment of the present disclosure, a processor is further provided. The processor is configured to run a program, wherein the program, when executed, performs any one of the above cryptographic operation processing methods.

In the example embodiments of the present disclosure, a cryptographic operation chip receives a cryptographic operation request; the cryptographic operation chip measures cryptographic operation algorithm firmware by using a cryptographic operation measurement root to obtain a first measurement result and sends the obtained first measurement result to a security chip; the cryptographic operation chip receives a comparison result fed back by the security chip, wherein the comparison result is a result determined by the security chip and indicating whether the first measurement result is the same as a second measurement result stored in advance; and the cryptographic operation chip performs a cryptographic operation when the comparison result indicates that the first measurement result is the same as the second measurement result. In this way, the algorithm firmware performing cryptographic operations is measured to make cryptographic operations more trusted, thereby effectively improving the credibility of cryptographic operations and solving the technical problem in the conventional techniques that cryptographic operation algorithm firmware cannot be measured and resulting in the credibility of cryptographic operations being low.

### BRIEF DESCRIPTION OF THE DRAWINGS

The accompanying drawings described herein are used for providing further understanding of the present disclosure and constitute a part of the present disclosure. The example embodiments of the present disclosure and description thereof are used for illustrating the present disclosure, and do not constitute a limitation to the present disclosure. In the drawings:

FIG. 1 is a structural hardware block diagram of a computer terminal (or a mobile device) configured to implement a cryptographic operation processing method according to an example embodiment of the present disclosure;

FIG. 2 is a flowchart of a cryptographic operation processing method according to Example embodiment 1 of the present disclosure;

FIG. 3 is a flowchart of another cryptographic operation processing method according to Example embodiment 1 of the present disclosure;

FIG. 4 is a flowchart of another cryptographic operation processing method according to Example embodiment 1 of the present disclosure;

FIG. 5 is a flowchart of another cryptographic operation processing method according to Example embodiment 1 of the present disclosure;

FIG. 6 is a schematic architectural diagram of building a measurement for trust chain based on a trusted high-speed encryption card according to Example embodiment 1 of the present disclosure;

FIG. 6A is a flowchart of a method for building a measurement for trust chain according to Example embodiment 1 of the present disclosure;

FIG. 7 is a flowchart of another cryptographic operation processing method according to Example embodiment 1 of the present disclosure;

FIG. 8 is a flowchart of a cryptographic operation processing method according to Example embodiment 2 of the present disclosure;

FIG. 9 is a flowchart of a cryptographic operation processing method according to Example embodiment 3;

FIG. 10 is a schematic structural diagram of a cryptographic operation processing apparatus according to Example embodiment 4 of the present disclosure;

FIG. 11 is a schematic structural diagram of a cryptographic operation processing apparatus according to Example embodiment 5 of the present disclosure;

FIG. 12 is a schematic structural diagram of a cryptographic operation processing system according to Example embodiment 6 of the present disclosure;

FIG. 13 is a schematic structural diagram of a system for building a measurement for trust chain according to Example embodiment 7 of the present disclosure; and

FIG. 14 is a structural block diagram of a computer terminal according to Example embodiment 8 of the present disclosure.

### DETAILED DESCRIPTION

To enable those skilled in the art to understand the solutions of the present disclosure, the technical solutions of the example embodiments of the present disclosure will be described clearly and completely below with reference to the accompanying drawings in the example embodiments of the present disclosure. Obviously, the described example embodiments merely represent some rather than all the example embodiments of the present disclosure. Based on the example embodiments in the present disclosure, all other example embodiments acquired by those of ordinary skill in the art without creative efforts shall belong to the protection scope of the present disclosure.

It should be noted that terms such as “first” and “second” in the specification, the claims and the accompanying drawings of the present disclosure are used to distinguish similar objects and are not intended to describe a specific sequence or order. It should be understood that data used in this manner may be interchanged in suitable situations, so that the example embodiments of the present disclosure described here may be implemented in sequences other than those shown or described here. Moreover, terms “include/include,” “have” and any variation thereof are intended to cover non-exclusive inclusion, for example, a process, method, system, product or device including a series of steps or units is not limited to those steps or units clearly listed, but may include other steps or units that are not explicitly listed or are inherent in the process, method, product or device.

First, some of the terms or phrases that appear in the process of describing the example embodiments of the present application are explained as follows:

Trusted Computing: which is to widely use a trusted computing platform supported by a hardware security module in computing and communication systems to improve the overall security of the system.

Trusted Platform Module/Trusted Platform Control Module (TPM/TPCM): which is a security chip providing integrity and authenticity guarantees for evidences, and generally is strongly bound to a computing platform in a physical manner.

Measurement for trust: a practical method for which is integrity measurement. Integrity measurement is to use a hash function to calculate a hash value of a code and compare the calculated hash code with a stored hash value to see whether the code has been changed, so that the system makes a corresponding determination according to the result of the comparison.

Field-Programmable Gate Array (FPGA): which is for example a semi-custom circuit and may achieve different logic gate functions by changing connections between logic blocks. The logic blocks and connections may be changed as designed to achieve an editable function.

Trusted high-speed Data Encryption Card (THSDEC): which is a data encryption card having trusted functions.

Firmware: which refers to programs which are stored in hardware and cannot be easily modified, and it also generally refers to underlying hardware where some of the programs reside.

### Example Embodiment 1

According to the example embodiments of the present disclosure, a method example embodiment of a cryptographic operation processing method is further provided. It should be noted that steps shown in the flowchart of the accompanying drawing may be executed in a computer system such as a set of computer executable instructions. Moreover, although a logic order is shown in the flowchart, in some cases, the shown or described steps may be executed in an order different from that described here.

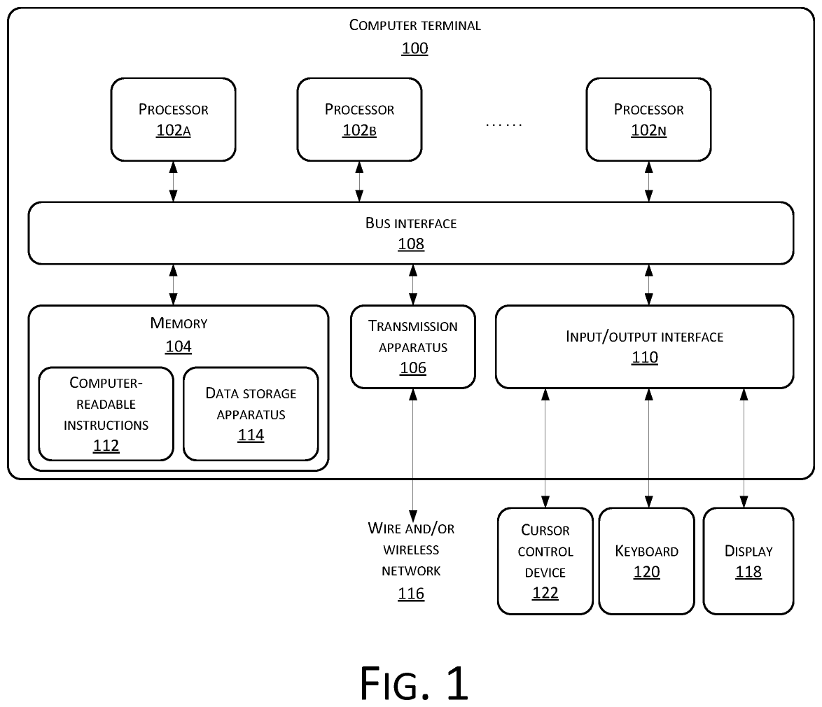

The method example embodiment provided in Example embodiment 1 of the present application may be executed in a mobile terminal, a computer terminal, or a similar computing device. FIG. 1 is a structural hardware block diagram of a computer terminal (or a mobile device) configured to implement a cryptographic operation processing method.

As shown in FIG. 1, a computer terminal 100 (such as a mobile device) may include one or more processors (shown as 102a, 102b, . . . , 102n in FIG. 1, wherein n may be any integer) (the processor(s) 102 may include, but is not limited to, a processing apparatus such as a microprocessor (MCU) or a programmable logic device (FPGA)), a memory 104 configured to store data, and a transmission apparatus 106 for communication functions. In addition, the computer terminal 100 may also include: a bus interface 108, an input/output interface (I/O interface) 110. The bus interface 108 transmits data between the processor 102, the memory 104, the transmission apparatus 106, and the input/output interface 110. For example, a universal serial bus (USB) port may be included as one of the ports of the I/O interface 110. The computer terminal 100 may also include a network interface, a power supply and/or a camera (not shown in FIG. 1). It will be understood by those skilled in the art that the structure shown in FIG. 1 is merely illustrative and does not limit the structure of the above electronic device. For example, the computer terminal 100 may also include more or fewer components than those shown in FIG. 1 or have a configuration different from that shown in FIG. 1.

It should be noted that the one or more processors 102 and/or other data processing circuits may generally be referred to as “data processing circuits” in the present disclosure. The data processing circuit may be embodied completely or partially as software, hardware, firmware or any other combination. Moreover, the data processing circuit may be a single, independent determining module, or incorporated completely or partially into any of other elements in the computer terminal 100. As referred to in the example embodiment of the present disclosure, the data processing circuit works as a processor to control, e.g., selection of a variable resistance terminal path connected to the interface.

The memory 104 may be configured to store software programs and modules of application software, such as computer-readable instructions 112 or data storage apparatus 114 corresponding to the file processing method in the example embodiment of the present disclosure. The processor 102 executes the software programs and modules stored in the memory 104, thus performing various functional applications and data processing, that is, implementing the file processing method. The memory 104 may include a high-speed random-access memory and may also include a non-volatile memory, such as one or more magnetic storage apparatuses, a flash memory, or other non-volatile solid-state memories. In some examples, the memory 104 may further include memories placed remote to the processor 102. These remote memories may be connected to the computer terminal 100 over a network. Examples of the network include, but are not limited to, the Internet, an intranet, a local area network, a mobile communication network, and a combination thereof.

The transmission apparatus 106 is configured to receive or send data via a network. A specific example of the network may include a wire and/or wireless network 116 provided by a communication provider of the computer terminal 100. In one example, the transmission apparatus 106 includes a Network Interface Controller (NIC) that may be connected to other network devices through a base station to communicate with the Internet. In one example, the transmission apparatus 106 may be a Radio Frequency (RF) module for communicating with the Internet wirelessly.

The input/out interface interacts with one or more peripheral device such as a display 118, a keyboard 120, and a cursor control device 122 such as a mouse.

The display 118 may be, for example, a touch screen-type liquid crystal display (LCD) that allows a user to interact with a user interface of the computer terminal 100.

The structural hardware block diagram shown in FIG. 1 may be used not only as an example block diagram of the computer terminal 100, but also as an example block diagram of the server. In an example embodiment, the computer terminal 100 may be connected or electronically connected to one or more servers (such as a secure server, a resource server, and a game server) via a data network. In an example embodiment, the computer terminal 100 may be any mobile computing device or the like. The data network connection may be a local area network connection, a wide area network connection, an Internet connection, or other type of data network connection. The computer terminal 100 may be connected to a network service that is executed by one server (for example, a security server) or a group of servers. The network service is a network-based user service such as a social network, cloud resources, email, online payment, or other online application.

In the use of computers, hardware attacks are a common form of virus intrusion, which uses a virus to modify firmware programs in hardware to cause a running fault or damage to the hardware, resulting in system down-time. In the prior art, a common way to solve hardware attacks is to improve the overall security of the system by performing trusted computing on the target hardware.

For example, the target hardware is measured to determine whether the target hardware is trusted. The measurement is a new technology for protecting platform and system integrity: measuring a target at certain moments to obtain some information about the target (such as a hash value of a file), and comparing values of the information with standard values recorded in advance, to determine whether the integrity of the target is damaged.

For existing Trusted Platform Modules (TPMs) and Trusted Platform Control Modules (TPCMs), in trusted high-speed encryption card scenarios, the high-speed encryption card includes a security chip configured to perform credibility monitoring and a cryptographic operation chip configured to perform a cryptographic operation. Credibility of an algorithm for processing cryptographic operations is tested at particular moments, for example, before delivery of the encryption card or during maintenance Trusted computing is performed on the encryption card. After the credibility test is passed, it is considered that the cryptographic operation algorithm in the encryption card is trusted. Therefore, the credibility of cryptographic operations may be improved to a certain extent. However, the trusted high-speed encryption card cannot ensure the integrity of the cryptographic operation algorithm during high-speed cryptographic operations each time when a high-speed cryptographic operation request is received from a user and cannot ensure the trusted loading and trusted dynamic execution of cryptographic operation firmware during high-speed cryptographic operations.

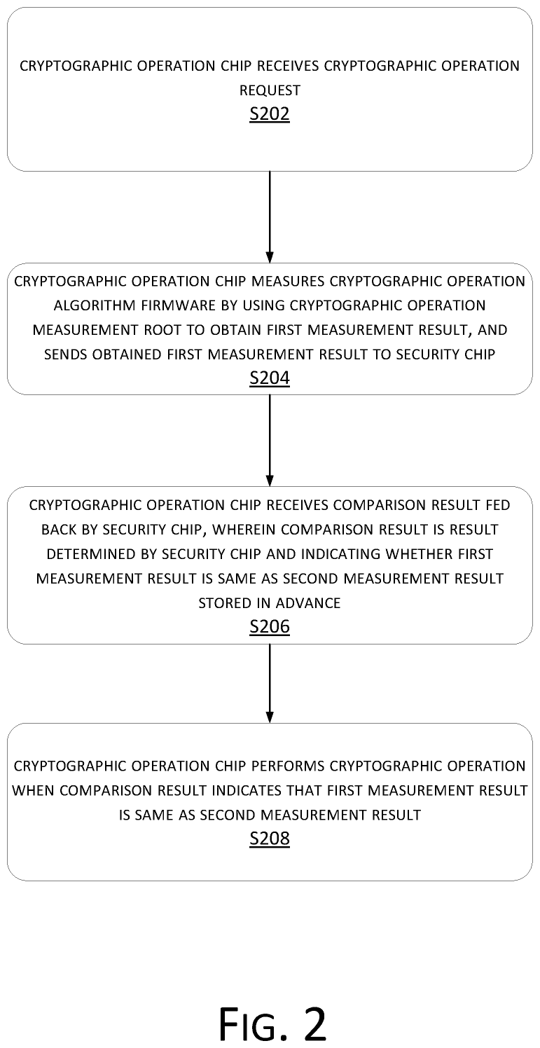

In the runtime environment, the present application provides a cryptographic operation processing method as shown in FIG. 2. FIG. 2 is a flowchart of a cryptographic operation processing method according to Example embodiment 1 of the present disclosure. As shown in FIG. 2, the cryptographic operation processing method includes the following method steps:

Step S202. A cryptographic operation chip receives a cryptographic operation request.

As an example embodiment, the cryptographic operation chip may be a chip configured to perform cryptographic operations or may be a cryptographic operation function module such as a cryptographic operation algorithm firmware configured to perform cryptographic operations in a chip.

As an example embodiment, the cryptographic operation request may be sent by the user to request the cryptographic operation chip to perform a cryptographic operation. When a cryptographic operation needs to be performed, the user sends a cryptographic operation request through a man-machine interface, and the cryptographic operation request is processed and sent to the cryptographic operation chip, so that the cryptographic operation chip performs the cryptographic operation.

As an example embodiment, the cryptographic operation chip may be a high-speed cryptographic operation chip.

As an example embodiment, the cryptographic operation request may include user information, a user platform identity certificate, a related attribute of the cryptographic operation request from the user, and the like. The user information may be identity information used for representing a user identity, and the like. The related attribute of the cryptographic operation request from the user may be a cryptographic operation algorithm, a key length, and the like to be used by the cryptographic operation.

As an example embodiment, after the cryptographic operation algorithm is measured once, the cryptographic operation chip considers that the cryptographic operation algorithm is trusted. After receiving a cryptographic operation request, the cryptographic operation chip considers by default that the cryptographic operation algorithm is trusted, and directly performs a cryptographic operation according to the cryptographic operation request.

Step S204. The cryptographic operation chip measures cryptographic operation algorithm firmware by using a cryptographic operation measurement root to obtain a first measurement result and sends the obtained first measurement result to a security chip.

As an example embodiment, the cryptographic operation algorithm firmware is measured by using the cryptographic operation measurement root, and the cryptographic operation measurement root may be a sub-function in the dynamic measurement module and is used for measuring the integrity of the cryptographic operation algorithm firmware.

It should be noted that the cryptographic operation chip may measure the cryptographic operation algorithm firmware in various manners, for example, by calculating a hash value of the cryptographic operation algorithm firmware, comparing the calculated hash value with a standard hash value recorded in advance to determine the integrity of the cryptographic operation algorithm firmware, and if the calculated hash value is the same as the standard hash value, determining that the cryptographic operation algorithm firmware is trusted, or if the calculated hash value is different from the standard hash value, determining that the cryptographic operation algorithm firmware is not trusted; for another example, by calculating a hash value of the cryptographic operation algorithm firmware, measuring the cryptographic operation algorithm firmware, and determining whether the cryptographic operation algorithm firmware is trusted.

As an example embodiment, the first measurement result may be the hash value, or may be other attribute information used for determining the cryptographic operation algorithm firmware. The measurement result is used for reflecting an attribute of the cryptographic operation algorithm firmware, and after the attribute passes the verification by the security chip, it may be considered that the cryptographic operation algorithm firmware is trusted.

As an example embodiment, the security chip may be a security chip configured to perform measurement for trust or may be a security function module configured to perform measurement for trust in a chip.

As an example embodiment, the first measurement result is sent to the security chip, and after receiving the first measurement result, the security chip performs trusted computing on the first measurement result, and feeds a result of the trusted computing back to the cryptographic operation chip to instruct the cryptographic operation chip to operate.

Step S206. The cryptographic operation chip receives a comparison result fed back by the security chip, wherein the comparison result is a result determined by the security chip and indicating whether the first measurement result is the same as a second measurement result stored in advance.

As an example embodiment, after receiving the first measurement result, the security chip may compare the first measurement result with the second measurement result directly stored in advance. The second measurement result is obtained through measurement after it is determined that the cryptographic operation algorithm firmware is trusted. It should be noted that the first measurement result and the second measurement result measure the same attribute quantity of the cryptographic operation algorithm firmware.

As an example embodiment, after receiving the first measurement result, the security chip may further perform processing and an operation on the first measurement result to obtain an operation result corresponding to the first measurement result, and compare the operation result with a result stored in advance to determine the credibility of the cryptographic operation algorithm firmware. It should be noted that the result stored in advance is also obtained through measurement when it is determined that the cryptographic operation algorithm firmware is trusted, and through the above processing and operation.

As an example embodiment, the cryptographic operation chip receives the comparison result fed back by the security chip, and the comparison result may reflect whether the cryptographic operation algorithm firmware in the cryptographic operation chip is trusted, and is for example represented by whether the first measurement result is the same as the second measurement result.

As an example embodiment, when the comparison result indicates that the security chip determines that the first measurement result is different from the second measurement result, it is considered that the cryptographic operation algorithm firmware measured by the first measurement result is not trusted; when the comparison result indicates that the security chip determines that the first measurement result is the same as the second measurement result, it is considered that the cryptographic operation algorithm firmware measured by the first measurement result is trusted.

As an example embodiment, when the cryptographic operation algorithm is trusted, the security chip sends the comparison result to the cryptographic operation chip, so that the cryptographic operation chip performs a subsequent action.

Step S208. The cryptographic operation chip performs a cryptographic operation when the comparison result indicates that the first measurement result is the same as the second measurement result.

As an example embodiment, the comparison result received by the cryptographic operation chip indicates that the first measurement result is the same as the second measurement result, indicating that the cryptographic operation algorithm firmware in the cryptographic operation chip is trusted.

As an example embodiment, when the cryptographic operation algorithm in the cryptographic operation chip is trusted, the cryptographic operation is executed, thereby ensuring that the cryptographic operation is trusted.

By performing measurement for trust on the cryptographic operation algorithm in the cryptographic operation chip, it is ensured that the cryptographic operation is trusted.

As an example embodiment, each time when a cryptographic operation request is received, measurement for trust is performed on the cryptographic operation algorithm in the cryptographic operation chip, so as to ensure credibility of a cryptographic operation performed in response to a cryptographic operation request by the cryptographic operation chip after receiving the cryptographic operation request.

In the example embodiments of the present disclosure, a cryptographic operation chip receives a cryptographic operation request; the cryptographic operation chip measures cryptographic operation algorithm firmware by using a cryptographic operation measurement root to obtain a first measurement result and sends the obtained first measurement result to a security chip; the cryptographic operation chip receives a comparison result fed back by the security chip, wherein the comparison result is a result determined by the security chip and indicating whether the first measurement result is the same as a second measurement result stored in advance; and the cryptographic operation chip performs a cryptographic operation when the comparison result indicates that the first measurement result is the same as the second measurement result. In this way, the algorithm firmware performing cryptographic operations is measured, cryptographic operations are made more trusted, thereby effectively improving the credibility of cryptographic operations and solving the technical problem in the conventional techniques that cryptographic operation algorithm firmware cannot be measured and consequently the credibility of cryptographic operations is low.

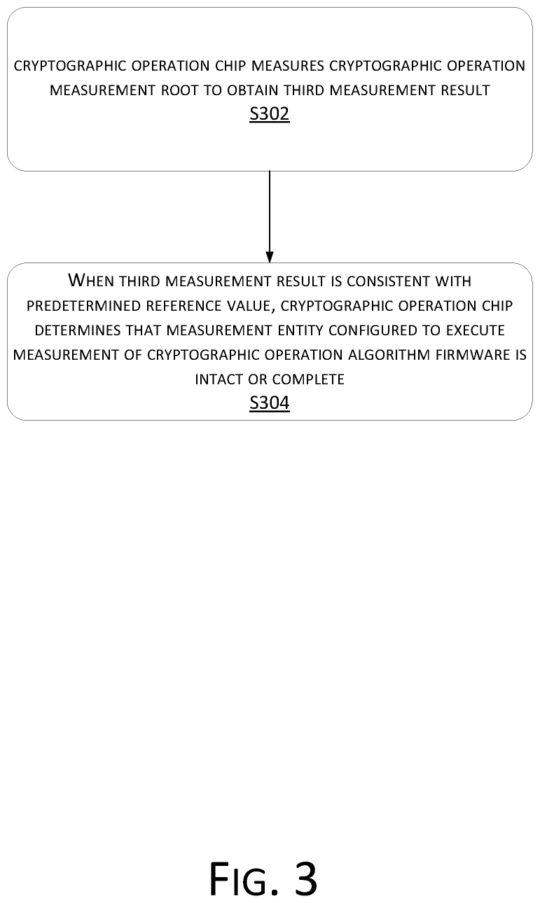

FIG. 3 is a flowchart of another cryptographic operation processing method according to Example embodiment 1 of the present disclosure. As shown in FIG. 3, as an example embodiment, before the measuring, by the cryptographic operation chip, cryptographic operation algorithm firmware by using a cryptographic operation measurement root, the method further includes:

step S302. The cryptographic operation chip measures the cryptographic operation measurement root to obtain a third measurement result; and

step S304. The cryptographic operation chip, when the third measurement result is consistent with a predetermined reference value, determines that a measurement entity configured to execute the measurement of the cryptographic operation algorithm firmware is intact or complete.

In this example embodiment, the cryptographic operation measurement root may be stored in the cryptographic operation chip, the cryptographic operation measurement root may be a functional module used for measuring the cryptographic operation algorithm in the cryptographic operation chip firmware, and the measurement root needs to be implemented by a measurement entity.

As an example embodiment, by measuring the cryptographic operation measurement root, the integrity of the measurement entity configured to measure the cryptographic operation may be determined, so as to ensure that the process of measurement for trust on the cryptographic operation algorithm in the cryptographic operation chip is trusted.

As an example embodiment, when the cryptographic operation chip measures the cryptographic operation measurement root, the third measurement result is obtained. The third measurement result may be the hash value or may be other attribute information used for determining the measurement entity configured to measure the cryptographic operation. The third measurement result is used for reflecting an attribute of the measurement entity configured to measure the cryptographic operation, and after the third measurement result passes the credibility verification, it may be considered that the measurement entity configured to measure the cryptographic operation is trusted.

As an example embodiment, when the credibility verification is performed on the third measurement result, the entity performing the verification operation may be the cryptographic operation chip, the security chip, or a chip having a cryptographic operation function module and a security module. In this example embodiment, the cryptographic operation chip is used as the execution entity.

As an example embodiment, when the third measurement result is consistent with the predetermined reference value, the cryptographic operation chip determines that a measurement entity configured to execute the measurement of the cryptographic operation algorithm firmware is intact. The predetermined reference value is an attribute value of the measurement entity measured when it is determined that the measurement entity is intact, and the attribute is the same as the attribute of the measurement entity measured by the third measurement result. The third measurement result and predetermined reference value may both have been subjected to equivalent or same processing and calculation.

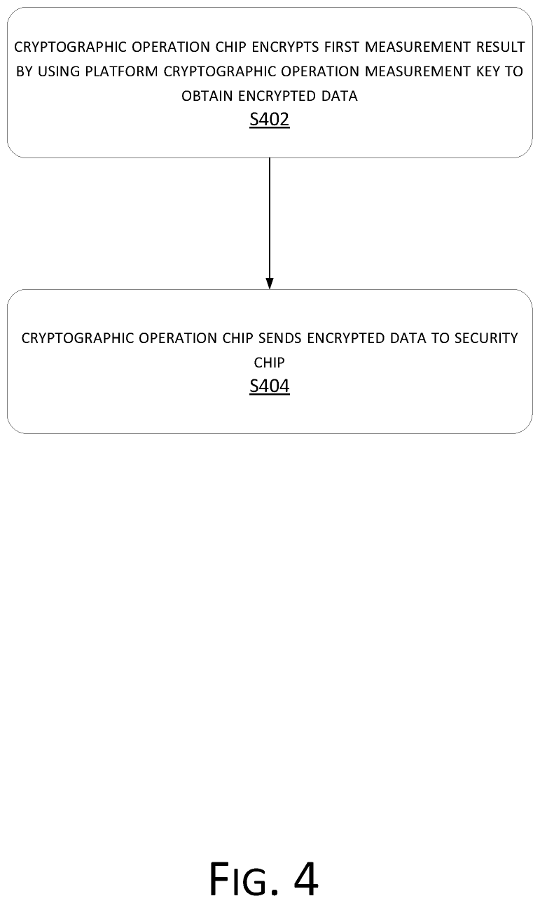

FIG. 4 is a flowchart of another cryptographic operation processing method according to Example embodiment 1 of the present disclosure. As shown in FIG. 4, as an example embodiment, the sending, by the cryptographic operation chip, the obtained first measurement result to a security chip includes:

step S402. The cryptographic operation chip encrypts the first measurement result by using a platform cryptographic operation measurement key to obtain encrypted data; and

step S404. The cryptographic operation chip sends the encrypted data to the security chip.

In this example embodiment, when measurement for trust is performed on the cryptographic operation algorithm in the cryptographic operation chip, the measurement result of the cryptographic operation algorithm firmware, that is, the first measurement result, needs to be sent to the security chip for the measurement for trust.

As an example embodiment, the first measurement result needs to be transmitted from the cryptographic operation chip to the security chip. During the transmission, the first measurement result is likely to be intercepted and tampered with. To prevent tampering of the first measurement result and ensure the correctness of the measurement for trust of the security chip, the first measurement result is transmitted in an encrypted manner in this example embodiment.

As an example embodiment, during the encrypted transmission of the first measurement result, the first measurement result is first encrypted by using the platform cryptographic operation measurement key to obtain the encrypted data. The platform cryptographic operation measurement key may be stored in or outside the cryptographic operation chip or may be stored in a chip having a cryptographic operation function module and a security function module.

In this example embodiment, the execution entity that encrypts the first measurement result by using the platform cryptographic operation measurement key to obtain the encrypted data is the cryptographic operation chip. The encrypted data is the encrypted first measurement result. The encrypted data may be obtained through various encryption methods. The encrypted data may be obtained through data transformation by using a certain encryption method.

As an example embodiment, the cryptographic operation chip sends the encrypted data to the security chip, and after receiving the encrypted data, the security chip decrypts the encrypted data to obtain the first measurement result, and then compares the first measurement result with the second measurement result stored in advance.

As an example embodiment, before the encrypting, by the cryptographic operation chip, the first measurement result by using a platform cryptographic operation measurement key to obtain encrypted data, the method further includes: encrypting, by the cryptographic operation chip, the cryptographic operation request by using a user platform identity public key to obtain a user cryptographic operation measurement key; and generating, by the cryptographic operation chip, the platform cryptographic operation measurement key according to the user cryptographic operation measurement key and a platform measurement root.

As an example embodiment, the first measurement result may be encrypted in various manners. In this example embodiment, the first measurement result is encrypted by using the platform cryptographic operation measurement key.

As an example embodiment, the platform cryptographic operation measurement key is generated based on the user cryptographic operation measurement key and the platform measurement root, and the execution entity of the above step may be the cryptographic operation chip.

As an example embodiment, the user cryptographic operation measurement key is obtained by decrypting the cryptographic operation request by using the user platform identity public key, and the execution entity of the above step may be the cryptographic operation chip.

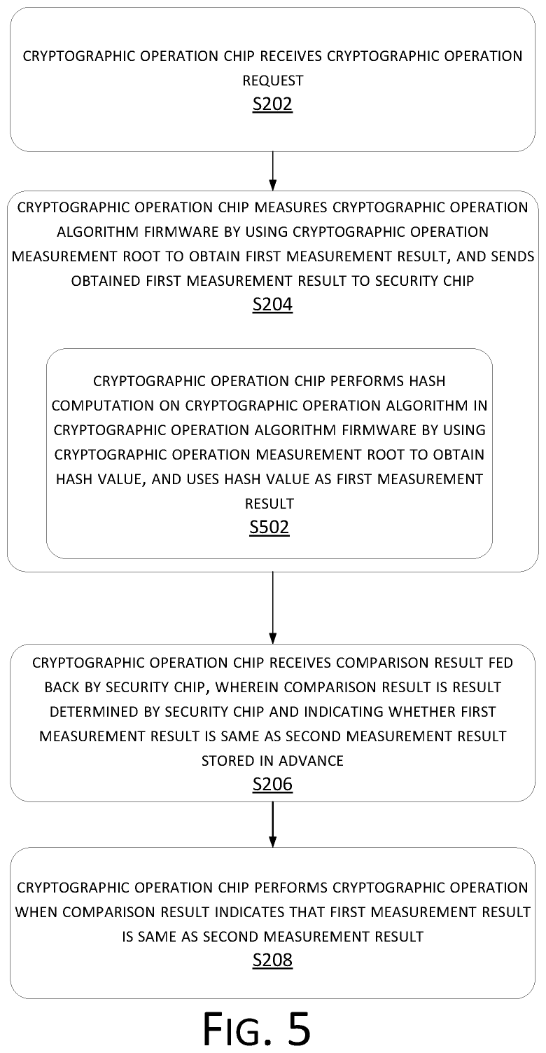

FIG. 5 is a flowchart of another cryptographic operation processing method according to Example embodiment 1 of the present disclosure. As shown in FIG. 5, as an example embodiment, the measuring, by the cryptographic operation chip, cryptographic operation algorithm firmware by using a cryptographic operation measurement root to obtain a first measurement result includes:

step S502. The cryptographic operation chip performs hash computation on a cryptographic operation algorithm (or computer-executable instructions or files representing the cryptographic operation algorithm) in the cryptographic operation algorithm firmware by using the cryptographic operation measurement root to obtain a hash value, and uses the hash value as the first measurement result.

In this example embodiment, when the cryptographic operation algorithm firmware in the cryptographic operation chip is measured to obtain the first measurement result, various measurement methods may be used, for example, multiple attributes of the cryptographic operation algorithm are measured. In this example embodiment, a hash value of the cryptographic operation algorithm in the cryptographic operation chip is calculated, wherein the hash value is a reference value used for proving whether the cryptographic operation algorithm firmware is intact.

As an example embodiment, hash computation is performed on the cryptographic operation algorithm, and the hash computation is a calculation method for acquiring the hash value of the cryptographic operation algorithm.

As an example embodiment, before the performing, by the cryptographic operation chip, hash computation on a cryptographic operation algorithm in the cryptographic operation algorithm firmware by using the cryptographic operation measurement root, the method further includes: determining, by the cryptographic operation chip, the cryptographic operation algorithm according to cryptographic operation attribute information carried in the cryptographic operation request.

As an example embodiment, there is a plurality of cryptographic operation algorithms in the cryptographic operation chip, and the cryptographic operation chip calls different cryptographic operation algorithms for different cryptographic operations. To avoid the involvement of all the cryptographic operation algorithms during computation, in this example embodiment, before the performing, by the cryptographic operation chip, hash computation on a cryptographic operation algorithm in the cryptographic operation algorithm firmware by using the cryptographic operation measurement root, the method further includes: determining, according to the cryptographic operation request, a cryptographic operation algorithm corresponding to the cryptographic operation request. In this way, during hash computation, the computation is performed only for the cryptographic operation algorithm, thereby effectively reducing the amount of computation and increasing the computation speed.

As an example embodiment, the determining, according to the cryptographic operation request, a cryptographic operation algorithm corresponding to the cryptographic operation request includes determining the cryptographic operation algorithm according to cryptographic operation attribute information carried in the cryptographic operation request.

As an example embodiment, before the measuring, by the cryptographic operation chip, cryptographic operation algorithm firmware by using a cryptographic operation measurement root, the method includes: verifying, by the cryptographic operation chip, validity of the cryptographic operation request according to a user platform identity certificate carried in the cryptographic operation request, and when the verification is successful, allowing the measurement of the cryptographic operation algorithm firmware.

As an example embodiment, the cryptographic operation chip receives the cryptographic operation request, and performs measurement for trust on the cryptographic operation algorithm firmware by using the cryptographic operation measurement root. When the cryptographic operation request is already tampered with, any operation performed by the cryptographic operation chip, including measurement of the cryptographic operation algorithm, encryption of the first measurement result, and the cryptographic operation, is useless. Therefore, after receiving the cryptographic operation request, the cryptographic operation chip needs to verify the cryptographic operation request. Only when the cryptographic operation request is trusted, will subsequent operations performed by the cryptographic operation chip be meaningful.

The cryptographic operation request may be verified in various manners. In this example embodiment, validity of the cryptographic operation request is verified according to the user platform identity certificate carried in the cryptographic operation request. When the cryptographic operation request passes the verification, the cryptographic operation algorithm firmware is allowed to be measured. When the cryptographic operation request does not pass the verification, no action is performed on the cryptographic operation request, and the result may be fed back to a control module or control chip, or may be fed back to an upper-level entity of the cryptographic operation chip in the data transmission and processing process.

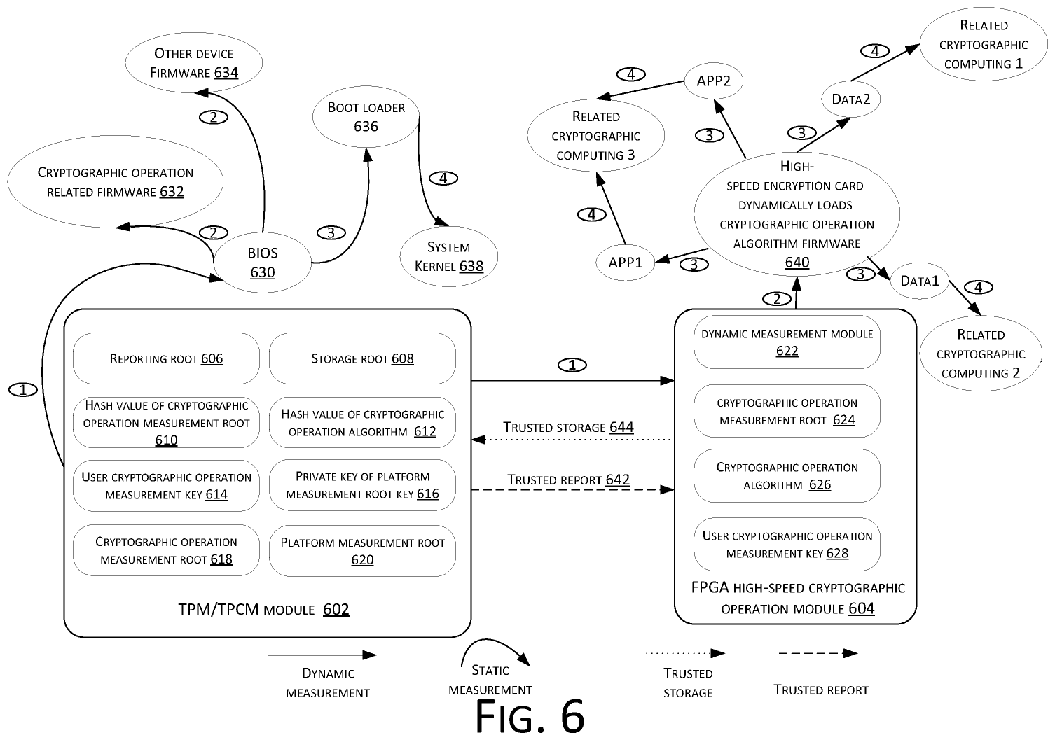

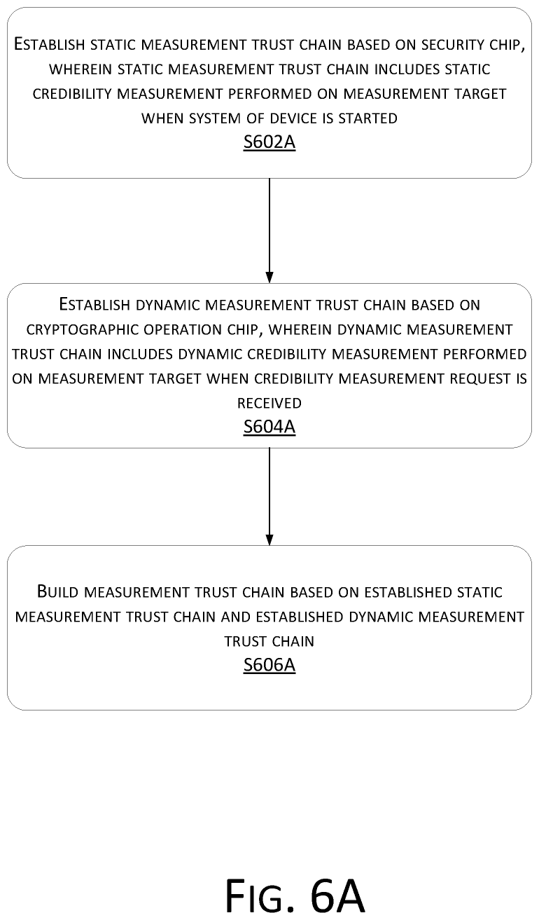

For ease of understanding, as an example implementation of this example embodiment, this example embodiment further provides a measurement for trust chain building architecture based on a trusted high-speed encryption card. FIG. 6 is a schematic architectural diagram of building a measurement for trust chain based on a trusted high-speed encryption card according to Example embodiment 1 of the present disclosure. As shown in FIG. 6, this implementation is described in detail below:

The building architecture is based on a trusted high-speed encryption card, and the trusted high-speed encryption card includes a TPM/TPCM module 602 and an FPGA high-speed cryptographic operation module 604.

During specific measurement for trust, from the perspective of the measurement time point, the measurement includes static measurement (the process shown on the left side of FIG. 6) and dynamic measurement (the process shown on the right side of FIG. 6). The static measurement means that the trusted high-speed encryption card participates in the establishment of a trust chain when the system is started and does not evaluate the trust chain after the system is started and during running of the system. The dynamic measurement means that each time a measurement for trust request is received, dynamic measurement for trust is performed on the measurement target.

From the perspective of the measurement target, the measurement includes platform system measurement and cryptographic operation measurement. The platform system measurement refers to security measurement related to the platform and system when and after the device is started and is implemented by a trusted module. The cryptographic operation measurement refers to measurement related to the cryptographic operation and is jointly implemented by the TPM/TPCM module 602 and the FPGA high-speed cryptographic operation module 604.

The trusted high-speed encryption card includes two parts: a trusted module such as the TPM/TPCM module 602 and a cryptographic operation module such as FPGA high-speed cryptographic operation module 604. The TPM/TPCM module 602 includes a reporting root 606, a storage root 608, a hash value of cryptographic operation measurement 610, a hash value of cryptographic operation algorithm 612, a user cryptographic operation measurement key 614, a private key of platform measurement root key 616, a cryptographic operation measurement root 618, and a platform measurement root 620. The FPGA high-speed cryptographic operation module 604 includes a dynamic measurement module 622, a cryptographic operation measurement root 624, a cryptographic operation algorithm 626, and a user cryptographic operation measurement key 628. For example, the user cryptographic operation measurement key 628 is the same as the user cryptographic operation measurement key 614, and the cryptographic operation measurement root 618 is the same as the cryptographic operation measurement root 624.

The above physical functions are described below:

The reporting root 606 is used for reporting to a remote user to prove that the integrity of the device platform and system is not damaged.

The storage root 608 is a storage root key of a trusted chip (the TPM/TPCM module 602) and is used for ensuring the security of other storage subkeys.

The dynamic measurement module 622 is a module configured to measure cryptographic operation related firmware during the cryptographic operation in the trusted high-speed encryption card.

The cryptographic operation measurement root 624 is one of sub-functions of the dynamic measurement module and is specially used for measuring the integrity of the cryptographic operation algorithm firmware.

The hash value of the cryptographic operation measurement root 610 is a reference value used for proving whether the measurement entity that measures the cryptographic operation algorithm firmware is intact.

The hash value of the cryptographic operation algorithm 612 is a reference value used for proving whether the cryptographic operation algorithm firmware is intact.

The user cryptographic operation measurement key 614 or the user cryptographic operation measurement key 628 is used for participating in the measurement of the cryptographic operation algorithm firmware, to ensure the trusted loading and trusted execution of the process of dynamic measurement of the cryptographic operation.

The private key of the platform measurement root key 616 is used for participating in the trusted loading and trusted execution of the dynamic measurement module during measurement.

The cryptographic operation measurement root 618 or the cryptographic operation measurement root 626 is used for measuring the integrity of the cryptographic operation algorithm.

The platform measurement root 620 is used for measuring the integrity of the dynamic measurement module 622.

The cryptographic operation algorithm 626 is an algorithm used for encrypting and decrypting data.

An example method for building according to the example embodiments of the present disclosure is described below. FIG. 6A is a flowchart of a method for building a measurement for trust chain according to Example embodiment 1 of the present disclosure. As shown in FIG. 6A, the method includes the following steps:

step S602A. establishing a static measurement for trust chain based on a security chip, wherein the static measurement for trust chain includes a static measurement for trust performed on a measurement target when a system of a device is started;

step S604A. establishing a dynamic measurement for trust chain based on a cryptographic operation chip, wherein the dynamic measurement for trust chain includes a dynamic measurement for trust performed on a measurement target when a measurement for trust request is received; and

step S606A. building a measurement for trust chain based on the established static measurement for trust chain and the established dynamic measurement for trust chain.

Based on the above steps, building of a trust chain by the trusted high-speed encryption card includes establishing a static measurement for trust chain, establishing a dynamic measurement for trust chain, and building a complete measurement for trust chain based on the establishment of the static measurement for trust chain and the establishment of the dynamic measurement for trust chain.

As shown in FIG. 6, as an example embodiment, the establishing a static measurement for trust chain based on a security chip may include: measuring the integrity of a basic input output system BIOS 630 based on the security chip, and when the obtained integrity measurement result indicates that the integrity is not damaged, actively measuring at least one piece of firmware in the device based on the BIOS; and when the integrity of one or more pieces of firmware in the device actively measured based on the BIOS is not damaged, loading the one or more pieces of firmware, and starting a system kernel of the device to complete the establishment of the static measurement for trust chain. For example, the establishment of the static measurement for trust chain based on the security chip may be as follows: TPCM/TPM module 602→BIOS (including measurement of the dynamic measurement module 622, the cryptographic operation measurement root 624, and the cryptographic operation related firmware 632 such as the cryptographic operation algorithm 626 in the FPGA high-speed cryptographic operation module 604, and other device firmware 634)→Boot Loader 636→System kernel 638.

As an example embodiment, the establishing a dynamic measurement for trust chain based on a cryptographic operation chip may include: measuring a dynamic measurement module based on the cryptographic operation chip to obtain a measurement result, wherein the dynamic measurement module is a measurement entity configured to measure cryptographic operation firmware; and when the measurement result indicates that integrity of the dynamic measurement module is not damaged, measuring cryptographic operation firmware and data based on the dynamic measurement module, and when a result of the measurement indicates that integrity of the cryptographic operation firmware is not damaged, determining that the establishment of the dynamic measurement for trust chain is completed. For example, the establishment of the dynamic measurement for trust chain based on the cryptographic operation chip may be as follows: TPCM/TPM module 602→dynamic measurement module 622 (including measurement of the cryptographic operation measurement root 624)→cryptographic operation related firmware and data (for example, cryptographic operation algorithm 626, application, and the like). The high-speed encrypted card dynamically loads the cryptographic operation algorithm firmware 640 to encrypt data such as data 1, data 2, application (app) 1, app 2 and conduct the corresponding cryptographic computing, such as the related cryptographic computing 1, the related cryptographic computing 2, and the related cryptographic computing 3 respectively.

As an example embodiment, building a measurement for trust chain based on the established static measurement for trust chain and the established dynamic measurement for trust chain may include: first determining that interaction between the security chip and the cryptographic operation chip is trusted; and then, building an intact measurement for trust chain based on the trusted interaction between the security chip and the cryptographic operation chip as well as the static measurement for trust chain and the dynamic measurement for trust chain. It should be noted that the trusted interaction between the security chip and the cryptographic operation chip may be implemented by using some roots exchanged, for example, by using the reporting root or the storage root. As shown in FIG. 6, the TPM/TPCM module 602 sends a trusted report 642, which may include the reporting root 606, to the FPGA high-speed cryptographic operation module 604. The FPGA high-speed cryptographic operation module 604 may send trusted storage 644, which may include trusted root keys, to the TPM/TPCM module 602 to be saved in the storage root 608.

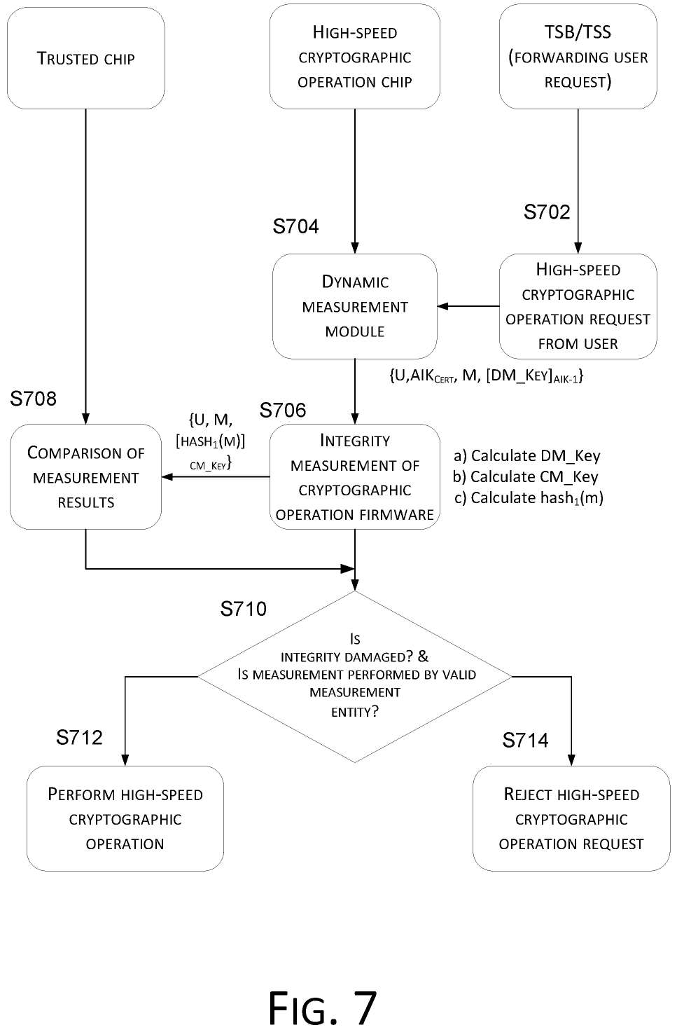

In addition, FIG. 7 is a flowchart of another cryptographic operation processing method according to Example embodiment 1 of the present disclosure. As shown in FIG. 7, this implementation further provides a method for dynamically measuring a trusted high-speed cryptographic operation, for example as follows:

At S702, a trusted software service (TSS)/trusted software base (TSB) forwards a cryptographic operation request from a user. The cryptographic operation request includes the following information: {U,AIK_{Cert},M, [DM_Key]_{AIK-1}}, wherein U represents user information, AIK_{Cert} represents the user platform identity certificate, M represents a related attribute of the cryptographic operation request from the user, for example, a cryptographic operation algorithm, a key length, and the like to be used by the cryptographic operation, and [DM_Key]_{AIK-1} represents information of the cryptographic operation request.

At S704, after the high-speed cryptographic operation module (that is, the cryptographic operation chip) receives the information, the dynamic measurement module therein verifies the validity of the AIK_{Cert} certificate of the user. If the certificate is not valid, the high-speed cryptographic operation module rejects the high-speed cryptographic operation request; otherwise, step 706 is performed.

At S706, dynamic measurement module measures the integrity of the cryptographic operation firmware such as the cryptographic operation algorithm firmware is measured by using the cryptographic operation measurement root (it should be noted that in this step, it is assumed that the trusted module has ensured the integrity of the dynamic measurement module including the cryptographic operation measurement root). This step is implemented as follows:

a) The information [DM_Key]AI_{K-1} is decrypted by using the user platform identity public key AIK to obtain DM_Key.

b) The platform cryptographic operation measurement key CM_Key is calculated, wherein CM_Key=f(DM_Key, Root_Skey), Root_Skey being the platform measurement root which may be obtained according to user information.

c) The cryptographic operation algorithm the hash value hash₁(m) is calculated, and the information {U, M, [hash₁(m)]_{CM_Key}} is sent to the trusted module, wherein m represents a cryptographic operation algorithm, and is obtained from the high-speed cryptographic operation module according to M in step 1).

At S708, the trusted module (that is, the security chip) receives the information {U, M, [hash₁(m)]_{CM_Ke}} from the high-speed cryptographic operation module, finds preset Root_Skey and DM_Key according to U, and calculates CM_Key=f(DM_Key, Root_Skey) according to a predetermined algorithm f; and then decrypts the information [hash₁(m)]_{CM_Key} by using CM_Key to obtain hash₁(m),finds a stored value of a corresponding cryptographic operation algorithm firmware according to M, determines whether hash1(m) is equal to hash₂(m), and feeds the result back to the high-speed cryptographic operation module.

At S710, the high-speed cryptographic operation module receives the result fed back by the trusted module. The high-speed cryptographic operation module determines whether the integrity is damaged & whether the measurement is performed by valid measurement entity. If the answer is yes, step S712 is performed; otherwise step S714 is performed.

At S712, the high-speed cryptographic operation is performed.

At S714, the high-speed cryptographic operation request is rejected.

### Example Embodiment 2

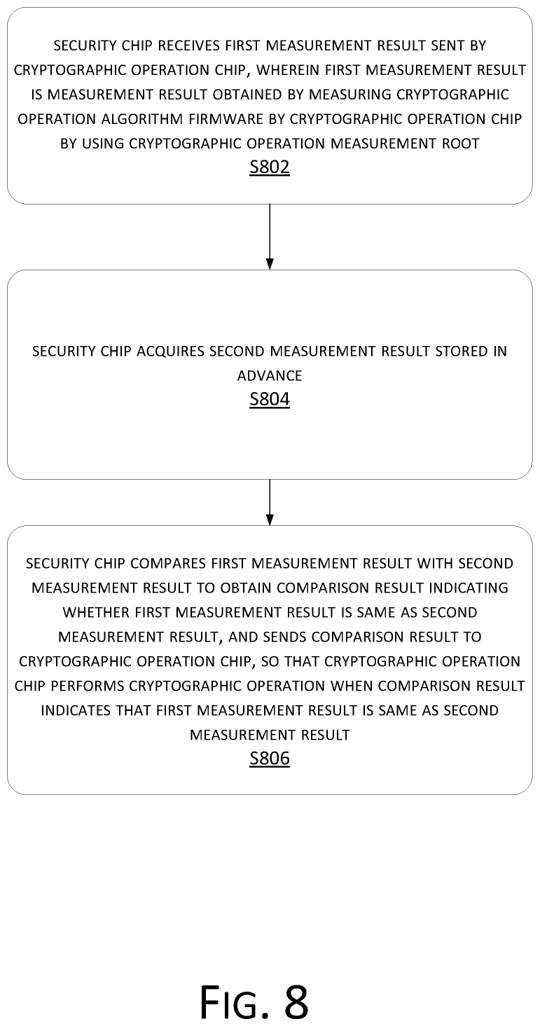

According to the example embodiments of the present disclosure, a method example embodiment of another cryptographic operation processing method is further provided. FIG. 8 is a flowchart of a cryptographic operation processing method according to Example embodiment 2 of the present disclosure. As shown in FIG. 8, the method includes the following steps:

Step S802. A security chip receives a first measurement result sent by a cryptographic operation chip, wherein the first measurement result is a measurement result obtained through measuring cryptographic operation algorithm firmware by the cryptographic operation chip using a cryptographic operation measurement root.

As an example embodiment, the security chip may be a security chip configured to perform measurement for trust or may be a security function module configured to perform measurement for trust in a chip. The cryptographic operation chip may be a chip configured to perform cryptographic operations or may be a cryptographic operation function module such as a cryptographic operation algorithm firmware configured to perform cryptographic operations in a chip.

As an example embodiment, the cryptographic operation request may be sent by the user to request the cryptographic operation chip to perform a cryptographic operation. When a cryptographic operation needs to be performed, the user sends a cryptographic operation request through a man-machine interface, and the cryptographic operation request is processed and sent to the cryptographic operation chip, so that the cryptographic operation chip performs the cryptographic operation.

As an example embodiment, the cryptographic operation chip may be a high-speed cryptographic operation chip.

As an example embodiment, the cryptographic operation request may include user information, a user platform identity certificate, a related attribute of the cryptographic operation request from the user, and the like. The user information may be identity information used for representing a user identity, and the like. The related attribute of the cryptographic operation request from the user may be a cryptographic operation algorithm, a key length, and the like to be used by the cryptographic operation.

As an example embodiment, after the cryptographic operation algorithm is measured once, the cryptographic operation chip considers that the cryptographic operation algorithm is trusted. After receiving a cryptographic operation request, the cryptographic operation chip considers by default that the cryptographic operation algorithm is trusted, and directly performs a cryptographic operation according to the cryptographic operation request.

As an example embodiment, the cryptographic operation algorithm firmware is measured by using the cryptographic operation measurement root, and the cryptographic operation measurement root may be a function of the dynamic measurement module.

As an example embodiment, the first measurement result may be the hash value, or may be other attribute information used for determining the cryptographic operation algorithm firmware. The measurement result is used for reflecting an attribute of the cryptographic operation algorithm firmware, and after the attribute passes the verification by the security chip, it may be considered that the cryptographic operation algorithm firmware is trusted.

Step S804. The security chip acquires a second measurement result stored in advance.

As an example embodiment, the security chip stores the second measurement result in advance. The second measurement result is obtained through measurement after it is determined that the cryptographic operation algorithm firmware is trusted. It should be noted that the first measurement result and the second measurement result measure the same attribute quantity of the cryptographic operation algorithm firmware.

As an example embodiment, the second measurement result may be obtained through measurement when it is determined that the cryptographic operation algorithm firmware is trusted, and through particular processing and operation. It should be noted that the same processing and operation method are adopted for the first measurement result and the second measurement result.

Step S806. The security chip compares the first measurement result with the second measurement result to obtain a comparison result indicating whether the first measurement result is the same as the second measurement result, and sends the comparison result to the cryptographic operation chip, so that the cryptographic operation chip performs a cryptographic operation when the comparison result indicates that the first measurement result is the same as the second measurement result.

As an example embodiment, after receiving the first measurement result, the security chip may compare the first measurement result with the second measurement result directly stored in advance. The second measurement result is obtained through measurement after it is determined that the cryptographic operation algorithm firmware is trusted. It should be noted that the first measurement result and the second measurement result measure the same attribute quantity of the cryptographic operation algorithm firmware.

As an example embodiment, after receiving the first measurement result, the security chip may further perform processing and an operation on the first measurement result to obtain an operation result corresponding to the first measurement result, and compare the operation result with a result stored in advance to determine the credibility of the cryptographic operation algorithm firmware. It should be noted that the result stored in advance is also obtained through measurement when it is determined that the cryptographic operation algorithm firmware is trusted, and through the above processing and operation.

As an example embodiment, the cryptographic operation chip receives the comparison result fed back by the security chip, and the comparison result may reflect whether the cryptographic operation algorithm firmware in the cryptographic operation chip is trusted, and is for example represented by whether the first measurement result is the same as the second measurement result.

As an example embodiment, when the comparison result indicates that the security chip determines that the first measurement result is different from the second measurement result, it is considered that the cryptographic operation algorithm firmware measured by the first measurement result is not trusted; when the comparison result indicates that the security chip determines that the first measurement result is the same as the second measurement result, it is considered that the cryptographic operation algorithm firmware measured by the first measurement result is trusted.

As an example embodiment, when the cryptographic operation algorithm is trusted, the security chip sends the comparison result to the cryptographic operation chip, so that the cryptographic operation chip performs a subsequent action.

The comparison result received by the cryptographic operation chip indicates that the first measurement result is the same as the second measurement result, indicating that the cryptographic operation algorithm firmware in the cryptographic operation chip is trusted.

When the cryptographic operation algorithm in the cryptographic operation chip is trusted, the cryptographic operation is executed, thereby ensuring that the cryptographic operation is trusted. By performing measurement for trust on the cryptographic operation algorithm in the cryptographic operation chip, it is ensured that the cryptographic operation is trusted.

As an example embodiment, each time when a cryptographic operation request is received, measurement for trust is performed on the cryptographic operation algorithm in the cryptographic operation chip, so as to ensure credibility of a cryptographic operation performed in response to a cryptographic operation request by the cryptographic operation chip after receiving the cryptographic operation request.

In the example embodiments of the present disclosure, a security chip receives a first measurement result sent by a cryptographic operation chip, wherein the first measurement result is a measurement result obtained through measuring cryptographic operation algorithm firmware by the cryptographic operation chip using a cryptographic operation measurement root; the security chip acquires a second measurement result stored in advance; the security chip compares the first measurement result with the second measurement result to obtain a comparison result indicating whether the first measurement result is the same as the second measurement result and sends the comparison result to the cryptographic operation chip, so that the cryptographic operation chip performs a cryptographic operation when the comparison result indicates that the first measurement result is the same as the second measurement result. In the way, the algorithm firmware performing cryptographic operations is measured, cryptographic operations are made more trusted, thereby effectively improving the credibility of cryptographic operations and solving the technical problem in the conventional techniques that cryptographic operation algorithm firmware cannot be measured and consequently the credibility of cryptographic operations is low.

As an example embodiment, the receiving, by a security chip, a first measurement result sent by a cryptographic operation chip includes: receiving, by the security chip, encrypted data sent by the cryptographic operation chip and obtained through encrypting the first measurement result by using a platform cryptographic operation measurement key; generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

As an example embodiment, when measurement for trust is performed on the cryptographic operation algorithm in the cryptographic operation chip, the measurement result of the cryptographic operation algorithm firmware, that is, the first measurement result, needs to be sent to the security chip for the measurement for trust.

As an example embodiment, the first measurement result needs to be transmitted from the cryptographic operation chip to the security chip. During the transmission, the first measurement result is likely to be intercepted and tampered with. To prevent tampering of the first measurement result and ensure the correctness of the measurement for trust of the security chip, the first measurement result is transmitted in an encrypted manner in this example embodiment.

As an example embodiment, during the encrypted transmission of the first measurement result, the first measurement result is first encrypted by using the platform cryptographic operation measurement key to obtain the encrypted data. The platform cryptographic operation measurement key may be stored in or outside the cryptographic operation chip or may be stored in a chip having a cryptographic operation function module and a security function module.

As an example embodiment, the execution entity that encrypts the first measurement result by using the platform cryptographic operation measurement key to obtain the encrypted data is the cryptographic operation chip. The encrypted data is the encrypted first measurement result. The encrypted data may be obtained through various encryption methods. The encrypted data may be obtained through data transformation by using a certain encryption method.

As an example embodiment, the cryptographic operation chip sends the encrypted data to the security chip, and after receiving the encrypted data, the security chip decrypts the encrypted data to obtain the first measurement result, and then compares the first measurement result with the second measurement result stored in advance.

As an example embodiment, the first measurement result may be encrypted in various manners. In this example embodiment, the first measurement result is encrypted by using the platform cryptographic operation measurement key.

As an example embodiment, the platform cryptographic operation measurement key is generated based on the user cryptographic operation measurement key and the platform measurement root, and the execution entity of the above step may be the cryptographic operation chip.

As an example embodiment, the user cryptographic operation measurement key is obtained by decrypting the cryptographic operation request by using the user platform identity public key, and the execution entity of the above step may be the cryptographic operation chip.

### Example Embodiment 3

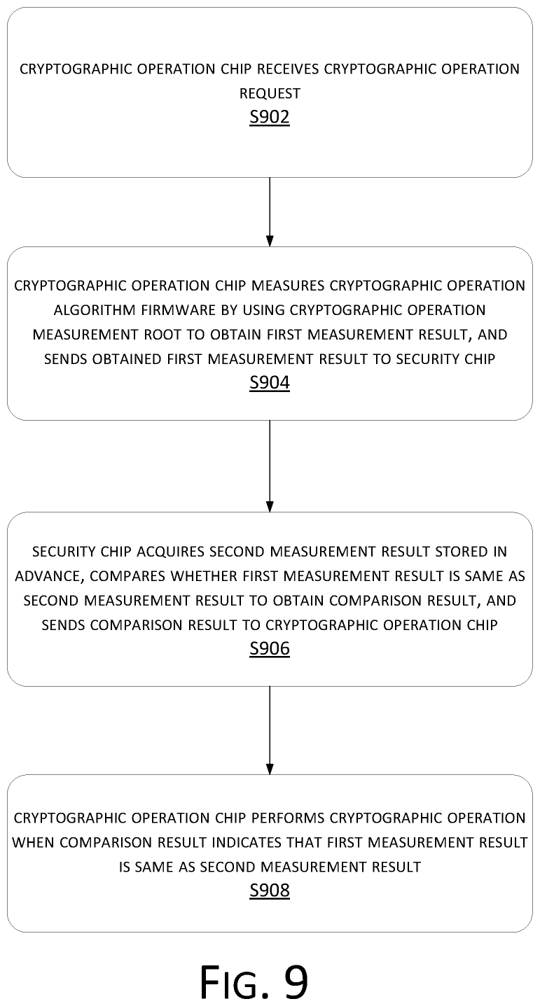

According to the example embodiments of the present disclosure, a method example embodiment of another cryptographic operation processing method is further provided. FIG. 9 is a flowchart of a cryptographic operation processing method according to Example embodiment 3 of the present disclosure. As shown in FIG. 9, the method includes the following steps:

Step S902. A cryptographic operation chip receives a cryptographic operation request.

As an example embodiment, the cryptographic operation chip may be a chip configured to perform cryptographic operations or may be a cryptographic operation function module such as a cryptographic operation algorithm firmware configured to perform cryptographic operations in a chip.

As an example embodiment, the cryptographic operation request may be sent by the user to request the cryptographic operation chip to perform a cryptographic operation. When a cryptographic operation needs to be performed, the user sends a cryptographic operation request through a man-machine interface, and the cryptographic operation request is processed and sent to the cryptographic operation chip, so that the cryptographic operation chip performs the cryptographic operation.

As an example embodiment, the cryptographic operation chip may be a high-speed cryptographic operation chip.

As an example embodiment, the cryptographic operation request may include user information, a user platform identity certificate, a related attribute of the cryptographic operation request from the user, and the like. The user information may be identity information used for representing a user identity, and the like. The related attribute of the cryptographic operation request from the user may be a cryptographic operation algorithm, a key length, and the like to be used by the cryptographic operation.

As an example embodiment, after the cryptographic operation algorithm is measured once, the cryptographic operation chip considers that the cryptographic operation algorithm is trusted. After receiving a cryptographic operation request, the cryptographic operation chip considers by default that the cryptographic operation algorithm is trusted, and directly performs a cryptographic operation according to the cryptographic operation request.

Step S904. The cryptographic operation chip measures cryptographic operation algorithm firmware by using a cryptographic operation measurement root to obtain a first measurement result and sends the obtained first measurement result to a security chip.

As an example embodiment, the cryptographic operation algorithm firmware is measured by using the cryptographic operation measurement root, and the cryptographic operation measurement root may be a measurement module configured to measure a program for executing the cryptographic operation algorithm, and is used for measuring the integrity of the program for executing the cryptographic operation algorithm.

As an example embodiment, the measurement module may reside in the cryptographic operation chip, or a functional module having a measurement function other than the cryptographic operation chip. The cryptographic operation chip may be a cryptographic operation module in a chip, and accordingly the measurement module is a functional module configured to measure the cryptographic operation module in the chip.

It should be noted that the cryptographic operation chip may measure the cryptographic operation algorithm firmware in various manners, for example, by calculating a hash value of the cryptographic operation algorithm firmware, comparing the calculated hash value with a standard hash value recorded in advance to determine the integrity of the cryptographic operation algorithm firmware, and if the calculated hash value is the same as the standard hash value, determining that the cryptographic operation algorithm firmware is trusted, or if the calculated hash value is different from the standard hash value, determining that the cryptographic operation algorithm firmware is not trusted; for another example, by calculating a hash value of the cryptographic operation algorithm firmware, measuring the cryptographic operation algorithm firmware, and determining whether the cryptographic operation algorithm firmware is trusted.

As an example embodiment, the first measurement result may be the hash value, or may be other attribute information used for determining the cryptographic operation algorithm firmware. The measurement result is used for reflecting an attribute of the cryptographic operation algorithm firmware, and after the attribute passes the verification by the security chip, it may be considered that the cryptographic operation algorithm firmware is trusted.

As an example embodiment, the security chip may be a security chip configured to perform measurement for trust or may be a security function module configured to perform measurement for trust in a chip.

As an example embodiment, the first measurement result is sent to the security chip, and after receiving the first measurement result, the security chip performs trusted computing on the first measurement result, and feeds a result of the trusted computing back to the cryptographic operation chip to instruct the cryptographic operation chip to operate.

Step S906. The security chip acquires a second measurement result stored in advance, compares whether the first measurement result is the same as the second measurement result to obtain a comparison result, and sends the comparison result to the cryptographic operation chip.

As an example embodiment, the security chip stores the second measurement result in advance. The second measurement result is obtained through measurement after it is determined that the cryptographic operation algorithm firmware is trusted. It should be noted that the first measurement result and the second measurement result measure the same attribute quantity of the cryptographic operation algorithm firmware.

As an example embodiment, the second measurement result may be obtained through measurement when it is determined that the cryptographic operation algorithm firmware is trusted, and through particular processing and operation. It should be noted that the same processing and operation method are adopted for the first measurement result and the second measurement result.

As an example embodiment, after receiving the first measurement result, the security chip may compare the first measurement result with the second measurement result directly stored in advance. The second measurement result is obtained through measurement after it is determined that the cryptographic operation algorithm firmware is trusted. It should be noted that the first measurement result and the second measurement result measure the same attribute quantity of the cryptographic operation algorithm firmware.

As an example embodiment, after receiving the first measurement result, the security chip may further perform processing and an operation on the first measurement result to obtain an operation result corresponding to the first measurement result, and compare the operation result with a result stored in advance to determine the credibility of the cryptographic operation algorithm firmware. It should be noted that the result stored in advance is also obtained through measurement when it is determined that the cryptographic operation algorithm firmware is trusted, and through the above processing and operation.

As an example embodiment, the cryptographic operation chip receives the comparison result fed back by the security chip, and the comparison result may reflect whether the cryptographic operation algorithm firmware in the cryptographic operation chip is trusted, and is for example represented by whether the first measurement result is the same as the second measurement result.

As an example embodiment, when the comparison result indicates that the security chip determines that the first measurement result is different from the second measurement result, it is considered that the cryptographic operation algorithm firmware measured by the first measurement result is not trusted; when the comparison result indicates that the security chip determines that the first measurement result is the same as the second measurement result, it is considered that the cryptographic operation algorithm firmware measured by the first measurement result is trusted.

As an example embodiment, when the cryptographic operation algorithm is trusted, the security chip sends the comparison result to the cryptographic operation chip, so that the cryptographic operation chip performs a subsequent action.

Step S908. The cryptographic operation chip performs a cryptographic operation when the comparison result indicates that the first measurement result is the same as the second measurement result.

As an example embodiment, the comparison result received by the cryptographic operation chip indicates that the first measurement result is the same as the second measurement result, indicating that the cryptographic operation algorithm firmware in the cryptographic operation chip is trusted.

As an example embodiment, when the cryptographic operation algorithm in the cryptographic operation chip is trusted, the cryptographic operation is executed, thereby ensuring that the cryptographic operation is trusted.

By performing measurement for trust on the cryptographic operation algorithm in the cryptographic operation chip, it is ensured that the cryptographic operation is trusted.

As an example embodiment, each time when a cryptographic operation request is received, measurement for trust is performed on the cryptographic operation algorithm in the cryptographic operation chip, so as to ensure credibility of a cryptographic operation performed in response to a cryptographic operation request by the cryptographic operation chip after receiving the cryptographic operation request.

In the example embodiments of the present disclosure, a cryptographic operation chip receives a cryptographic operation request; the cryptographic operation chip measures cryptographic operation algorithm firmware by using a cryptographic operation measurement root to obtain a first measurement result and sends the obtained first measurement result to a security chip; the cryptographic operation chip receives a comparison result fed back by the security chip, wherein the comparison result is a result determined by the security chip and indicating whether the first measurement result is the same as a second measurement result stored in advance; and the cryptographic operation chip performs a cryptographic operation when the comparison result indicates that the first measurement result is the same as the second measurement result. In this way, the algorithm firmware performing cryptographic operations is measured, cryptographic operations are made more trusted, thereby effectively improving the credibility of cryptographic operations and solving the technical problem in the conventional techniques that cryptographic operation algorithm firmware cannot be measured and consequently the credibility of cryptographic operations is low.

As an example embodiment, the sending, by the cryptographic operation chip, the obtained first measurement result to a security chip includes: encrypting, by the cryptographic operation chip, the first measurement result by using a platform cryptographic operation measurement key to obtain encrypted data; and sending, by the cryptographic operation chip, the encrypted data to the security chip; and before the comparing, by the security chip, whether the first measurement result is the same as the second measurement result to obtain a comparison result, the method further includes: generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

As an example embodiment, when measurement for trust is performed on the cryptographic operation algorithm in the cryptographic operation chip, the measurement result of the cryptographic operation algorithm firmware, that is, the first measurement result, needs to be sent to the security chip for the measurement for trust.

As an example embodiment, the first measurement result needs to be transmitted from the cryptographic operation chip to the security chip. During the transmission, the first measurement result is likely to be intercepted and tampered with. To prevent tampering of the first measurement result and ensure the correctness of the measurement for trust of the security chip, the first measurement result is transmitted in an encrypted manner in this example embodiment.

As an example embodiment, during the encrypted transmission of the first measurement result, the first measurement result is first encrypted by using the platform cryptographic operation measurement key to obtain the encrypted data. The platform cryptographic operation measurement key may be stored in or outside the cryptographic operation chip or may be stored in a chip having a cryptographic operation function module and a security function module.

As an example embodiment, the execution entity that encrypts the first measurement result by using the platform cryptographic operation measurement key to obtain the encrypted data is the cryptographic operation chip. The encrypted data is the encrypted first measurement result. The encrypted data may be obtained through various encryption methods. The encrypted data may be obtained through data transformation by using a certain encryption method.

As an example embodiment, the cryptographic operation chip sends the encrypted data to the security chip, and after receiving the encrypted data, the security chip decrypts the encrypted data to obtain the first measurement result, and then compares the first measurement result with the second measurement result stored in advance.

As an example embodiment, before the measuring, by the cryptographic operation chip, cryptographic operation algorithm firmware by using a cryptographic operation measurement root, the method includes acquiring, by the cryptographic operation chip, the cryptographic operation measurement root from the security chip.

The cryptographic operation measurement root may be stored in or outside the security chip or may be stored in a chip having a security module and a cryptographic operation function module.

It should be noted that, for ease of description, the method example embodiments mentioned above are all described as a series of action combinations. However, those skilled in the art should know that the present disclosure is not limited to the action order described here, this is because some steps may be performed in other orders or simultaneously according to the present disclosure. Next, those skilled in the art should know that the example embodiments described in the specification are all preferred example embodiments, and actions and modules involved therein are not necessary for the present disclosure.

Based on the foregoing descriptions of the implementations, those skilled in the art may clearly understand that the method according to the above example embodiment may be implemented by software plus a necessary universal hardware platform, and definitely, may also be implemented by hardware; however, in most situations, the former is a better implementation manner. Based on such understanding, the technical solution of the present disclosure essentially, or the portion contributing to the prior art may be embodied in the form of a software product. The software product may be stored in a storage medium, such as a ROM/RAM, a magnetic disk, or an optical disc, and include several instructions that enable a terminal device (which may be a mobile phone, a computer, a server, a network device or the like) to perform the method in the example embodiments of the present disclosure.

### Example Embodiment 4

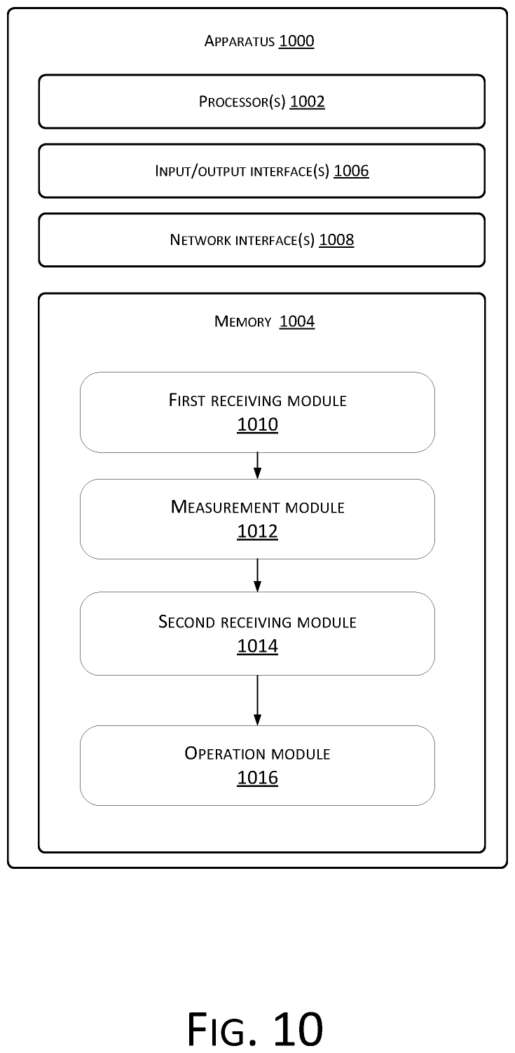

According to the example embodiments of the present disclosure, a cryptographic operation processing apparatus configured to implement Example embodiment 1 is further provided. FIG. 10 is a schematic structural diagram of a cryptographic operation processing apparatus according to Example embodiment 4 of the present disclosure.

As shown in FIG. 10, an apparatus 1000 includes one or more processor(s) 1002 or data processing unit(s) and memory 1004. The apparatus 1000 may further include one or more input/output interface(s) 1006 and one or more network interface(s) 1008. The memory 1004 is an example of computer readable medium or media. For example, the apparatus 1000 is a cryptographic operation chip.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 1004 may store therein a plurality of modules or units including a first receiving module 1010, a measurement module 1012, a second receiving module 1014 and an operation module 1016.

The first receiving module 1010 is configured to receive a cryptographic operation request. The measurement module 1012 is connected to the first receiving module 1010 and configured to measure cryptographic operation algorithm firmware by using a cryptographic operation measurement root to obtain a first measurement result and send the obtained first measurement result to a security chip. The second receiving module 1014 is connected to the measurement module 1012, and configured to receive a comparison result fed back by the security chip, wherein the comparison result is a result determined by the security chip and indicating whether the first measurement result is the same as a second measurement result stored in advance. The operation module 1016 is connected to the second receiving module 1014 configured to perform a cryptographic operation when the comparison result indicates that the first measurement result is the same as the second measurement result.

In addition, it should be noted that the first receiving module 1010, the measurement module 1012, the second receiving module 1014, and the operation module 1016 correspond to step S202 to step S208 in Example embodiment 1, and examples achieved by and application scenarios of the four modules are the same as those of the corresponding steps, but are not limited to the content disclosed in Example embodiment 1. It should be noted that the above modules may run as part of the apparatus in the computer terminal 10 provided in Example embodiment 1.

### Example Embodiment 5

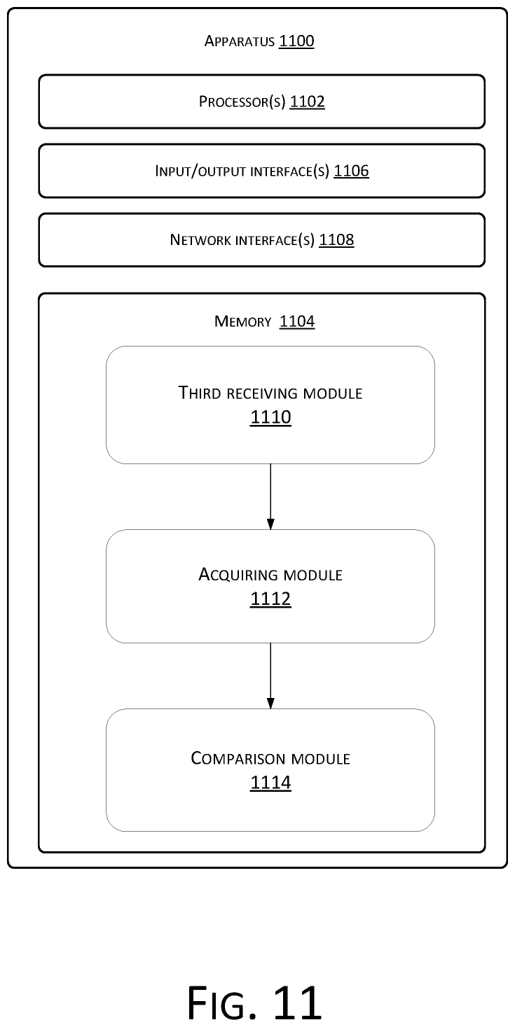

According to the example embodiments of the present disclosure, a cryptographic operation processing apparatus configured to implement Example embodiment 2 is further provided. FIG. 11 is a schematic structural diagram of a cryptographic operation processing apparatus according to Example embodiment 5 of the present disclosure.

As shown in FIG. 11, an apparatus 1100 includes one or more processor(s) 1102 or data processing unit(s) and memory 1104. The apparatus 1100 may further include one or more input/output interface(s) 1106 and one or more network interface(s) 1108. The memory 1104 is an example of computer readable medium or media. For example, the apparatus 1100 is a security chip.

The memory 1104 may store therein a plurality of modules or units including a third receiving module 1110, an acquiring module 1112 and a comparison module 1114.

The third receiving module 1110 is configured to receive a first measurement result sent by the cryptographic operation chip, wherein the first measurement result is a measurement result obtained through measuring cryptographic operation algorithm firmware by the cryptographic operation chip using a cryptographic operation measurement root. The acquiring module 1112 is connected to the third receiving module 1110 and configured to acquire a second measurement result stored in advance. The comparison module 1114 is connected to the acquiring module 1112, and configured to compare the first measurement result with the second measurement result to obtain a comparison result indicating whether the first measurement result is the same as the second measurement result, and send the comparison result to the cryptographic operation chip, so that the cryptographic operation chip performs a cryptographic operation when the comparison result indicates that the first measurement result is the same as the second measurement result.

In addition, it should be noted that the third receiving module 1110, the acquiring module 1112, and the comparison module 1114 correspond to step S802 to step S806 in Example embodiment 2, and examples achieved by and application scenarios of the three modules are the same as those of the corresponding steps, but are not limited to the content disclosed in Example embodiment 1. It should be noted that the above modules may run as part of the apparatus in the computer terminal 10 provided in Example embodiment 1.

### Example Embodiment 6

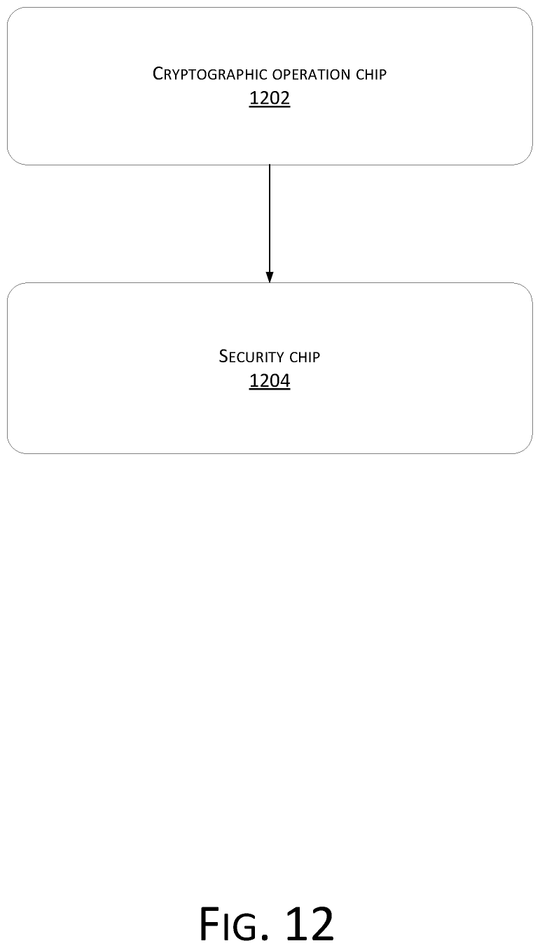

According to the example embodiments of the present disclosure, a cryptographic operation processing system configured to implement the cryptographic operation processing method is further provided. FIG. 12 is a schematic structural diagram of a cryptographic operation processing system according to Example embodiment 6 of the present disclosure. As shown in FIG. 12, the system includes: a cryptographic operation chip 1202 and a security chip 1204. The system is described in detail below.

The cryptographic operation chip 1202 is configured to receive a cryptographic operation request, measure cryptographic operation algorithm firmware by using a cryptographic operation measurement root to obtain a first measurement result, and send the obtained first measurement result to a security chip.

The security chip 1204 communicates with the cryptographic operation chip 1202, and is configured to acquire a second measurement result stored in advance, compare whether the first measurement result is the same as the second measurement result to obtain a comparison result, and send the comparison result to the cryptographic operation chip.

The cryptographic operation chip 1202 is further configured to perform a cryptographic operation when the comparison result indicates that the first measurement result is the same as the second measurement result.

### Example Embodiment 7

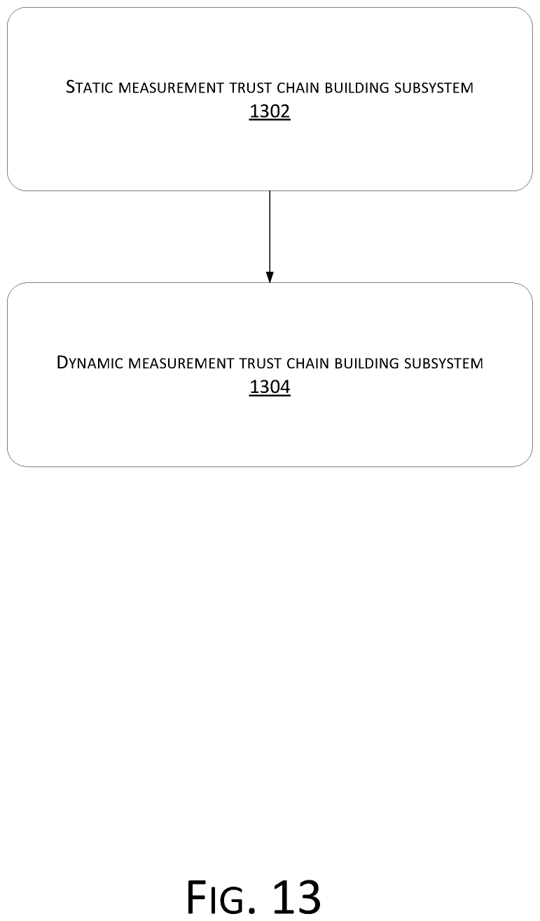

According to the example embodiments of the present disclosure, a system for building a measurement for trust chain configured to implement the method for building a measurement for trust chain is further provided. FIG. 13 is a schematic structural diagram of a system for building a measurement for trust chain according to Example embodiment 7 of the present disclosure. As shown in FIG. 13, the system includes: a static measurement trust chain building subsystem 1302 and a dynamic measurement trust chain building subsystem 1304. The system for building a measurement for trust chain is described below.

The static measurement trust chain building subsystem 1302 is configured to establish a static measurement for trust chain based on a security chip, wherein the static measurement for trust chain includes a static measurement for trust performed on a measurement target when a system of a device is started.

The dynamic measurement trust chain building subsystem 1304 is configured to establish a dynamic measurement for trust chain based on a cryptographic operation chip, wherein the dynamic measurement for trust chain includes a dynamic measurement for trust performed on a measurement target when a measurement for trust request is received.

The static measurement trust chain building subsystem 1302 and the dynamic measurement trust chain building subsystem 1304 are further configured to build a measurement for trust chain based on the established static measurement for trust chain and the established dynamic measurement for trust chain.

### Example Embodiment 8

The example embodiments of the present disclosure may provide a computer terminal. The computer terminal may be any computer terminal device in a computer terminal group. For example, in this example embodiment, the computer terminal may also be replaced with a terminal device such as a mobile terminal.

For example, in this example embodiment, the computer terminal may be located in at least one of multiple network devices in a computer network.

In this example embodiment, the computer terminal may execute program codes of the following steps in a cryptographic operation processing method in an application: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; receiving, by the cryptographic operation chip, a comparison result fed back by the security chip, wherein the comparison result is a result determined by the security chip and indicating whether the first measurement result is the same as a second measurement result stored in advance; and performing, by the cryptographic operation chip, a cryptographic operation when the comparison result indicates that the first measurement result is the same as the second measurement result.

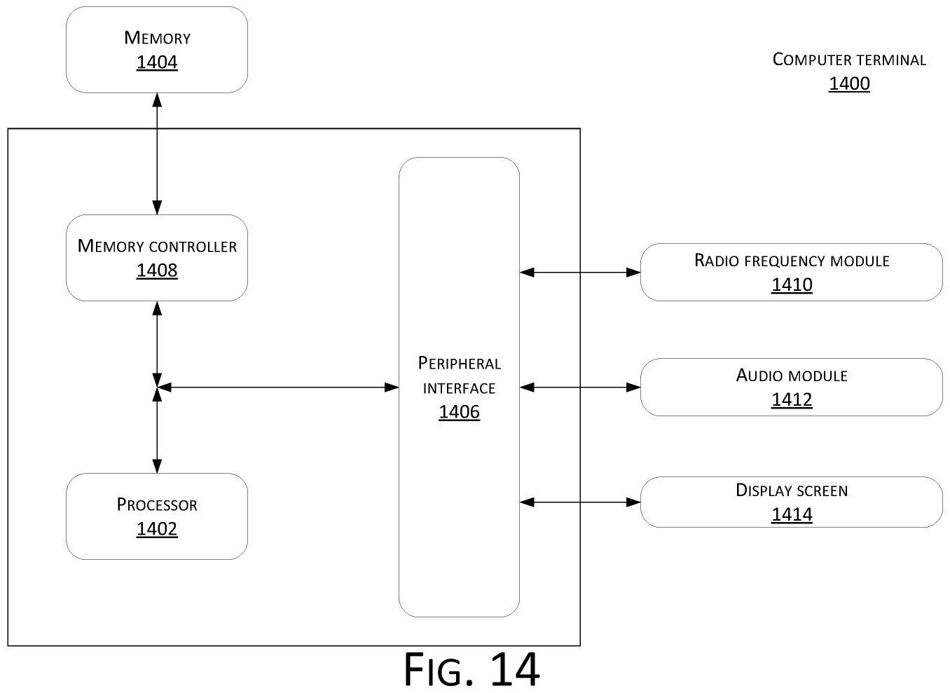

For example, FIG. 14 is a structural block diagram of a computer terminal according to Example embodiment 8 of the present disclosure. As shown in FIG. 14, the computer terminal 1400 may include: one or more (only one is shown) processors 1402, a memory 1404, and a peripheral interface 1406. The memory 1404 communicated with a memory controller 1408 that interacts with the processors 1402 and a peripherical interface 1406. The peripheral interface 1406 interacts with a radio frequency module 1410, an audio module 1412, and a display 1414.

The memory 1404 may be configured to store a software program and a module, e.g., a program instruction/module corresponding to the cryptographic operation processing method and apparatus in the example embodiments of the present disclosure. The processor runs the software program and module stored in the memory, to execute various function applications and perform data processing, i.e., implement the cryptographic operation processing method. The memory may include a high-speed random-access memory, and may further include a non-volatile memory, e.g., one or more magnetic storage apparatuses, a flash memory, or another non-volatile solid-state memory. In some examples, the memory may further include memories remotely disposed with respect to the processor, and the remote memories may be connected to the computer terminal 130 through a network. Examples of the network include, but are not limited to, the Internet, an Intranet, a local area network, a mobile communication network, and their combinations.

The processor 1402 may use the transmission apparatus to call the information and the application stored in the memory, to perform the following steps: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; receiving, by the cryptographic operation chip, a comparison result fed back by the security chip, wherein the comparison result is a result determined by the security chip and indicating whether the first measurement result is the same as a second measurement result stored in advance; and performing, by the cryptographic operation chip, a cryptographic operation when the comparison result indicates that the first measurement result is the same as the second measurement result.

For example, the processor 1402 may further execute program codes of the following steps: before the measuring, by the cryptographic operation chip, cryptographic operation algorithm firmware by using a cryptographic operation measurement root, the method includes: measuring, by the cryptographic operation chip, the cryptographic operation measurement root to obtain a third measurement result; and determining, by the cryptographic operation chip when the third measurement result is consistent with a predetermined reference value, that a measurement entity configured to execute the measurement of the cryptographic operation algorithm firmware is intact.

For example, the processor 1402 may further execute program codes of the following steps: the sending, by the cryptographic operation chip, the obtained first measurement result to a security chip includes: encrypting, by the cryptographic operation chip, the first measurement result by using a platform cryptographic operation measurement key to obtain encrypted data; and sending, by the cryptographic operation chip, the encrypted data to the security chip.

For example, the processor 1402 may further execute program codes of the following steps: before the encrypting, by the cryptographic operation chip, the first measurement result by using a platform cryptographic operation measurement key to obtain encrypted data, the method further includes: encrypting, by the cryptographic operation chip, the cryptographic operation request by using a user platform identity public key to obtain a user cryptographic operation measurement key; and generating, by the cryptographic operation chip, the platform cryptographic operation measurement key according to the user cryptographic operation measurement key and a platform measurement root.

For example, the processor 1402 may further execute program codes of the following steps: the measuring, by the cryptographic operation chip, cryptographic operation algorithm firmware by using a cryptographic operation measurement root to obtain a first measurement result includes: performing, by the cryptographic operation chip, hash computation on a cryptographic operation algorithm in the cryptographic operation algorithm firmware by using the cryptographic operation measurement root to obtain a hash value, and using, by the cryptographic operation chip, the hash value as the first measurement result.

For example, the processor 1402 may further execute program codes of the following steps: before the performing, by the cryptographic operation chip, hash computation on a cryptographic operation algorithm in the cryptographic operation algorithm firmware by using the cryptographic operation measurement root, the method further includes: determining, by the cryptographic operation chip, the cryptographic operation algorithm according to cryptographic operation attribute information carried in the cryptographic operation request.

For example, the processor 1402 may further execute program codes of the following steps: before the measuring, by the cryptographic operation chip, cryptographic operation algorithm firmware by using a cryptographic operation measurement root, the method includes: verifying, by the cryptographic operation chip, validity of the cryptographic operation request according to a user platform identity certificate carried in the cryptographic operation request, and when the verification is successful, allowing the measurement of the cryptographic operation algorithm firmware.

A cryptographic operation chip receives a cryptographic operation request; the cryptographic operation chip measures cryptographic operation algorithm firmware by using a cryptographic operation measurement root to obtain a first measurement result and sends the obtained first measurement result to a security chip; the cryptographic operation chip receives a comparison result fed back by the security chip, wherein the comparison result is a result determined by the security chip and indicating whether the first measurement result is the same as a second measurement result stored in advance; and the cryptographic operation chip performs a cryptographic operation when the comparison result indicates that the first measurement result is the same as the second measurement result. In this way, the algorithm firmware performing cryptographic operations is measured, cryptographic operations are made more trusted, thereby effectively improving the credibility of cryptographic operations and solving the technical problem in the conventional techniques that cryptographic operation algorithm firmware cannot be measured and consequently the credibility of cryptographic operations is low.

### Example Embodiment 9

The example embodiments of the present disclosure may provide a computer terminal. The computer terminal may be any computer terminal device in a computer terminal group. For example, in this example embodiment, the computer terminal may also be replaced with a terminal device such as a mobile terminal.

For example, in this example embodiment, the computer terminal may be located in at least one of multiple network devices in a computer network.

In this example embodiment, the computer terminal may execute program codes of the following steps in a cryptographic operation processing method in an application: receiving, by a security chip, a first measurement result sent by a cryptographic operation chip, wherein the first measurement result is a measurement result obtained through measuring cryptographic operation algorithm firmware by the cryptographic operation chip using a cryptographic operation measurement root; acquiring, by the security chip, a second measurement result stored in advance; and comparing, by the security chip, the first measurement result with the second measurement result to obtain a comparison result indicating whether the first measurement result is the same as the second measurement result, and sending, by the security chip, the comparison result to the cryptographic operation chip, so that the cryptographic operation chip performs a cryptographic operation when the comparison result indicates that the first measurement result is the same as the second measurement result.

For example, the example embodiments of the present disclosure provide a computer terminal. The computer terminal may include: one or more processors, a memory, and a peripheral interface.

The memory may be configured to store a software program and a module, e.g., a program instruction/module corresponding to the cryptographic operation processing method and apparatus in the example embodiments of the present disclosure. The processor runs the software program and module stored in the memory, to execute various function applications and perform data processing, i.e., implement the cryptographic operation processing method. The memory may include a high-speed random-access memory, and may further include a non-volatile memory, e.g., one or more magnetic storage apparatuses, a flash memory, or another non-volatile solid-state memory. In some examples, the memory may further include memories remotely disposed with respect to the processor, and the remote memories may be connected to a terminal through a network. Examples of the network include, but are not limited to, the Internet, an Intranet, a local area network, a mobile communication network, and their combinations.

The processor may use the transmission apparatus to call the information and the application stored in the memory, to perform the following steps: receiving, by a security chip, a first measurement result sent by a cryptographic operation chip, wherein the first measurement result is a measurement result obtained through measuring cryptographic operation algorithm firmware by the cryptographic operation chip using a cryptographic operation measurement root; acquiring, by the security chip, a second measurement result stored in advance; and comparing, by the security chip, the first measurement result with the second measurement result to obtain a comparison result indicating whether the first measurement result is the same as the second measurement result, and sending, by the security chip, the comparison result to the cryptographic operation chip, so that the cryptographic operation chip performs a cryptographic operation when the comparison result indicates that the first measurement result is the same as the second measurement result.

For example, the processor may further execute program codes of the following steps: the receiving, by a security chip, a first measurement result sent by a cryptographic operation chip includes: receiving, by the security chip, encrypted data sent by the cryptographic operation chip and obtained through encrypting the first measurement result by using a platform cryptographic operation measurement key; generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

In the example embodiments of the present disclosure, a security chip receives a first measurement result sent by a cryptographic operation chip, wherein the first measurement result is a measurement result obtained through measuring cryptographic operation algorithm firmware by the cryptographic operation chip using a cryptographic operation measurement root; the security chip acquires a second measurement result stored in advance; the security chip compares the first measurement result with the second measurement result to obtain a comparison result indicating whether the first measurement result is the same as the second measurement result and sends the comparison result to the cryptographic operation chip, so that the cryptographic operation chip performs a cryptographic operation when the comparison result indicates that the first measurement result is the same as the second measurement result. In the way, the algorithm firmware performing cryptographic operations is measured, the cryptographic operations are made more trusted, thereby effectively improving the credibility of cryptographic operations and solving the technical problem in the conventional techniques that cryptographic operation algorithm firmware cannot be measured and consequently the credibility of cryptographic operations is low.

### Example Embodiment 10

The example embodiments of the present disclosure may provide a computer terminal. The computer terminal may be any computer terminal device in a computer terminal group. For example, in this example embodiment, the computer terminal may also be replaced with a terminal device such as a mobile terminal.

For example, in this example embodiment, the computer terminal may be located in at least one of multiple network devices in a computer network.

In this example embodiment, the computer terminal may execute program codes of the following steps in a cryptographic operation processing method in an application: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; acquiring, by the security chip, a second measurement result stored in advance, comparing, by the security chip, whether the first measurement result is the same as the second measurement result to obtain a comparison result, and sending, by the security chip, the comparison result to the cryptographic operation chip; and performing, by the cryptographic operation chip, a cryptographic operation when the comparison result indicates that the first measurement result is the same as the second measurement result.

For example, the example embodiments of the present disclosure provide a computer terminal. The computer terminal may include: one or more processors, a memory, and a peripheral interface.

The memory may be configured to store a software program and a module, e.g., a program instruction/module corresponding to the cryptographic operation processing method and apparatus in the example embodiments of the present disclosure. The processor runs the software program and module stored in the memory, to execute various function applications and perform data processing, i.e., implement the cryptographic operation processing method. The memory may include a high-speed random-access memory, and may further include a non-volatile memory, e.g., one or more magnetic storage apparatuses, a flash memory, or another non-volatile solid-state memory. In some examples, the memory may further include memories remotely disposed with respect to the processor, and the remote memories may be connected to a terminal through a network. Examples of the network include, but are not limited to, the Internet, an Intranet, a local area network, a mobile communication network, and their combinations.

The processor may use the transmission apparatus to call the information and the application stored in the memory, to perform the following steps: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; acquiring, by the security chip, a second measurement result stored in advance, comparing, by the security chip, whether the first measurement result is the same as the second measurement result to obtain a comparison result, and sending, by the security chip, the comparison result to the cryptographic operation chip; and performing, by the cryptographic operation chip, a cryptographic operation when the comparison result indicates that the first measurement result is the same as the second measurement result.

For example, the processor may further execute program codes of the following steps: the sending, by the cryptographic operation chip, the obtained first measurement result to a security chip includes: encrypting, by the cryptographic operation chip, the first measurement result by using a platform cryptographic operation measurement key to obtain encrypted data; and sending, by the cryptographic operation chip, the encrypted data to the security chip; and before the comparing, by the security chip, whether the first measurement result is the same as the second measurement result to obtain a comparison result, the method further includes: generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

For example, the processor may further execute program codes of the following steps: before the measuring, by the cryptographic operation chip, cryptographic operation algorithm firmware by using a cryptographic operation measurement root, the method includes: acquiring, by the cryptographic operation chip, the cryptographic operation measurement root from the security chip.

In the example embodiments of the present disclosure, a cryptographic operation chip receives a cryptographic operation request; the cryptographic operation chip measures cryptographic operation algorithm firmware by using a cryptographic operation measurement root to obtain a first measurement result and sends the obtained first measurement result to a security chip; the cryptographic operation chip receives a comparison result fed back by the security chip, wherein the comparison result is a result determined by the security chip and indicating whether the first measurement result is the same as a second measurement result stored in advance; and the cryptographic operation chip performs a cryptographic operation when the comparison result indicates that the first measurement result is the same as the second measurement result. In this way, the algorithm firmware performing cryptographic operations is measured, cryptographic operations are made more trusted, thereby effectively improving the credibility of cryptographic operations and solving the technical problem in the conventional techniques that cryptographic operation algorithm firmware cannot be measured and consequently the credibility of cryptographic operations is low.

### Example Embodiment 11

The example embodiments of the present disclosure may provide a computer terminal. The computer terminal may be any computer terminal device in a computer terminal group. For example, in this example embodiment, the computer terminal may also be replaced with a terminal device such as a mobile terminal.

For example, in this example embodiment, the computer terminal may be located in at least one of multiple network devices in a computer network.

In this example embodiment, the computer terminal may execute program codes of the following steps in a method for building a measurement for trust chain in an application: establishing a static measurement for trust chain based on a security chip, wherein the static measurement for trust chain includes a static measurement for trust performed on a measurement target when a system of a device is started; establishing a dynamic measurement for trust chain based on a cryptographic operation chip, wherein the dynamic measurement for trust chain includes a dynamic measurement for trust performed on a measurement target when a measurement for trust request is received; and building a measurement for trust chain based on the established static measurement for trust chain and the established dynamic measurement for trust chain.

For example, the example embodiments of the present disclosure provide a computer terminal. The computer terminal may include: one or more processors, a memory, and a peripheral interface.

The memory may be configured to store a software program and a module, e.g., a program instruction/module corresponding to the cryptographic operation processing method and apparatus in the example embodiments of the present disclosure. The processor runs the software program and module stored in the memory, to execute various function applications and perform data processing, i.e., implement the cryptographic operation processing method. The memory may include a high-speed random-access memory, and may further include a non-volatile memory, e.g., one or more magnetic storage apparatuses, a flash memory, or another non-volatile solid-state memory. In some examples, the memory may further include memories remotely disposed with respect to the processor, and the remote memories may be connected to a terminal through a network. Examples of the network include, but are not limited to, the Internet, an Intranet, a local area network, a mobile communication network, and their combinations.

The processor may use the transmission apparatus to call the information and the application stored in the memory, to perform the following steps: establishing a static measurement for trust chain based on a security chip, wherein the static measurement for trust chain includes a static measurement for trust performed on a measurement target when a system of a device is started; establishing a dynamic measurement for trust chain based on a cryptographic operation chip, wherein the dynamic measurement for trust chain includes a dynamic measurement for trust performed on a measurement target when a measurement for trust request is received; and building a measurement for trust chain based on the established static measurement for trust chain and the established dynamic measurement for trust chain.

For example, the processor may further execute program codes of the following steps: the establishing a static measurement for trust chain based on a security chip includes: measuring the integrity of a basic input output system BIOS based on the security chip, and when the obtained integrity measurement result indicates that the integrity is not damaged, actively measuring at least one piece of firmware in the device based on the BIOS; and when the integrity of one or more pieces of firmware in the device actively measured based on the BIOS is not damaged, loading the one or more pieces of firmware, and starting a system kernel of the device to complete the establishment of the static measurement for trust chain.

For example, the processor may further execute program codes of the following steps: the establishing a dynamic measurement for trust chain based on a cryptographic operation chip includes: measuring a dynamic measurement module based on the cryptographic operation chip to obtain a measurement result, wherein the dynamic measurement module is a measurement entity configured to measure cryptographic operation firmware; and when the measurement result indicates that integrity of the dynamic measurement module is not damaged, measuring cryptographic operation firmware and data based on the dynamic measurement module, and when a result of the measurement indicates that integrity of the cryptographic operation firmware is not damaged, determining that the establishment of the dynamic measurement for trust chain is completed.

For example, the processor may further execute program codes of the following steps: building a measurement for trust chain based on the established static measurement for trust chain and the established dynamic measurement for trust chain includes: determining that interaction between the security chip and the cryptographic operation chip is trusted; and building an intact measurement for trust chain based on the trusted interaction between the security chip and the cryptographic operation chip as well as the static measurement for trust chain and the dynamic measurement for trust chain.

In the example embodiments of the present disclosure, the establishing a static measurement for trust chain based on a security chip, wherein the static measurement for trust chain includes a static measurement for trust performed on a measurement target when a system of a device is started; establishing a dynamic measurement for trust chain based on a cryptographic operation chip, wherein the dynamic measurement for trust chain includes a dynamic measurement for trust performed on a measurement target when a measurement for trust request is received; and building a measurement for trust chain based on the established static measurement for trust chain and the established dynamic measurement for trust chain. A complete measurement for trust chain is built through the above processing.

Those of ordinary skill in the art may understand that the computer terminal may also be a terminal device such as a smart phone (such as an Android phone and an iOS phone), a tablet computer, a handheld computer, a Mobile Internet Devices (MID), and a PAD. This example embodiment does not limit the structure of the above electronic apparatus. For example, the computer terminal may include more or fewer components (such as a network interface and a display apparatus) than those shown in this example embodiment or have a configuration different from that shown in this example embodiment.

Those of ordinary skill may understand that all or part of the steps in the methods in the above example embodiments may be implemented through a program instructing hardware related to a terminal device. The program may be stored in a computer readable storage medium. The storage medium may include: a flash memory disk, a Read-Only Memory (ROM), a Random-Access Memory (RAM), a magnetic disk, an optical disc, or the like.

### Example Embodiment 12

The example embodiments of the present disclosure further provide a storage medium. For example, in this example embodiment, the storage medium may be configured to store program codes executed in the cryptographic operation processing method provided by Example embodiment 1.

For example, in this example embodiment, the storage medium may be located in any computer terminal in a computer terminal group in a computer network or located in any mobile terminal in a mobile terminal group.

For example, in this example embodiment, the storage medium is configured to store program codes for performing the following steps: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; receiving, by the cryptographic operation chip, a comparison result fed back by the security chip, wherein the comparison result is a result determined by the security chip and indicating whether the first measurement result is the same as a second measurement result stored in advance; and performing, by the cryptographic operation chip, a cryptographic operation when the comparison result indicates that the first measurement result is the same as the second measurement result.

For example, in this example embodiment, the storage medium is configured to store program codes for performing the following steps: before the measuring, by the cryptographic operation chip, cryptographic operation algorithm firmware by using a cryptographic operation measurement root, the method includes: measuring, by the cryptographic operation chip, the cryptographic operation measurement root to obtain a third measurement result; and determining, by the cryptographic operation chip when the third measurement result is consistent with a predetermined reference value, that a measurement entity configured to execute the measurement of the cryptographic operation algorithm firmware is intact.

For example, in this example embodiment, the storage medium is configured to store program codes for performing the following steps: the sending, by the cryptographic operation chip, the obtained first measurement result to a security chip includes: encrypting, by the cryptographic operation chip, the first measurement result by using a platform cryptographic operation measurement key to obtain encrypted data; and sending, by the cryptographic operation chip, the encrypted data to the security chip.

For example, in this example embodiment, the storage medium is configured to store program codes for performing the following steps: before the encrypting, by the cryptographic operation chip, the first measurement result by using a platform cryptographic operation measurement key to obtain encrypted data, the method further includes: encrypting, by the cryptographic operation chip, the cryptographic operation request by using a user platform identity public key to obtain a user cryptographic operation measurement key; and generating, by the cryptographic operation chip, the platform cryptographic operation measurement key according to the user cryptographic operation measurement key and a platform measurement root.

For example, in this example embodiment, the storage medium is configured to store program codes for performing the following steps: the measuring, by the cryptographic operation chip, cryptographic operation algorithm firmware by using a cryptographic operation measurement root to obtain a first measurement result includes: performing, by the cryptographic operation chip, hash computation on a cryptographic operation algorithm in the cryptographic operation algorithm firmware by using the cryptographic operation measurement root to obtain a hash value, and using, by the cryptographic operation chip, the hash value as the first measurement result.

For example, in this example embodiment, the storage medium is configured to store program codes for performing the following steps: before the performing, by the cryptographic operation chip, hash computation on a cryptographic operation algorithm in the cryptographic operation algorithm firmware by using the cryptographic operation measurement root, the method further includes: determining, by the cryptographic operation chip, the cryptographic operation algorithm according to cryptographic operation attribute information carried in the cryptographic operation request.

For example, in this example embodiment, the storage medium is configured to store program codes for performing the following steps: before the measuring, by the cryptographic operation chip, cryptographic operation algorithm firmware by using a cryptographic operation measurement root, the method includes: verifying, by the cryptographic operation chip, validity of the cryptographic operation request according to a user platform identity certificate carried in the cryptographic operation request, and when the verification is successful, allowing the measurement of the cryptographic operation algorithm firmware.

### Example Embodiment 13

The example embodiments of the present disclosure further provide a storage medium. For example, in this example embodiment, the storage medium may be configured to store program codes executed in the cryptographic operation processing method provided by Example embodiment 2.

For example, in this example embodiment, the storage medium may be located in any computer terminal in a computer terminal group in a computer network or located in any mobile terminal in a mobile terminal group.

For example, in this example embodiment, the storage medium is configured to store program codes for performing the following steps: receiving, by a security chip, a first measurement result sent by a cryptographic operation chip, wherein the first measurement result is a measurement result obtained through measuring cryptographic operation algorithm firmware by the cryptographic operation chip using a cryptographic operation measurement root; acquiring, by the security chip, a second measurement result stored in advance; and comparing, by the security chip, the first measurement result with the second measurement result to obtain a comparison result indicating whether the first measurement result is the same as the second measurement result, and sending, by the security chip, the comparison result to the cryptographic operation chip, so that the cryptographic operation chip performs a cryptographic operation when the comparison result indicates that the first measurement result is the same as the second measurement result.

For example, in this example embodiment, the storage medium is configured to store program codes for performing the following steps: the receiving, by a security chip, a first measurement result sent by a cryptographic operation chip: receiving, by the security chip, encrypted data sent by the cryptographic operation chip and obtained through encrypting the first measurement result by using a platform cryptographic operation measurement key; generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

### Example Embodiment 14

The example embodiments of the present disclosure further provide a storage medium. For example, in this example embodiment, the storage medium may be configured to store program codes executed in the cryptographic operation processing method provided by Example embodiment 3.

For example, in this example embodiment, the storage medium may be located in any computer terminal in a computer terminal group in a computer network or located in any mobile terminal in a mobile terminal group.

For example, in this example embodiment, the storage medium is configured to store program codes for performing the following steps: receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip; acquiring, by the security chip, a second measurement result stored in advance, comparing, by the security chip, whether the first measurement result is the same as the second measurement result to obtain a comparison result, and sending, by the security chip, the comparison result to the cryptographic operation chip; and performing, by the cryptographic operation chip, a cryptographic operation when the comparison result indicates that the first measurement result is the same as the second measurement result.

For example, in this example embodiment, the storage medium is configured to store program codes for performing the following steps: the sending, by the cryptographic operation chip, the obtained first measurement result to a security chip includes: encrypting, by the cryptographic operation chip, the first measurement result by using a platform cryptographic operation measurement key to obtain encrypted data; and sending, by the cryptographic operation chip, the encrypted data to the security chip; and before the comparing, by the security chip, whether the first measurement result is the same as the second measurement result to obtain a comparison result, the method further includes: generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

For example, in this example embodiment, the storage medium is configured to store program codes for performing the following steps: before the measuring, by the cryptographic operation chip, cryptographic operation algorithm firmware by using a cryptographic operation measurement root, the method includes: acquiring, by the cryptographic operation chip, the cryptographic operation measurement root from the security chip.

### Example Embodiment 15

The example embodiments of the present disclosure further provide a storage medium. For example, in this example embodiment, the storage medium may be configured to store program codes executed in the method for building a measurement for trust chain according to Example embodiment 1.

For example, in this example embodiment, the storage medium may be located in any computer terminal in a computer terminal group in a computer network or located in any mobile terminal in a mobile terminal group.

For example, in this example embodiment, the storage medium is configured to store program codes for performing the following steps: establishing a static measurement for trust chain based on a security chip, wherein the static measurement for trust chain includes a static measurement for trust performed on a measurement target when a system of a device is started; establishing a dynamic measurement for trust chain based on a cryptographic operation chip, wherein the dynamic measurement for trust chain includes a dynamic measurement for trust performed on a measurement target when a measurement for trust request is received; and building a measurement for trust chain based on the established static measurement for trust chain and the established dynamic measurement for trust chain.

For example, in this example embodiment, the storage medium is configured to store program codes for performing the following steps: the establishing a static measurement for trust chain based on a security chip includes: measuring the integrity of a basic input output system BIOS based on the security chip, and when the obtained integrity measurement result indicates that the integrity is not damaged, actively measuring at least one piece of firmware in the device based on the BIOS; and when the integrity of one or more pieces of firmware in the device actively measured based on the BIOS is not damaged, loading the one or more pieces of firmware, and starting a system kernel of the device to complete the establishment of the static measurement for trust chain.

For example, in this example embodiment, the storage medium is configured to store program codes for performing the following steps: the establishing a dynamic measurement for trust chain based on a cryptographic operation chip includes: measuring a dynamic measurement module based on the cryptographic operation chip to obtain a measurement result, wherein the dynamic measurement module is a measurement entity configured to measure cryptographic operation firmware; and when the measurement result indicates that integrity of the dynamic measurement module is not damaged, measuring cryptographic operation firmware and data based on the dynamic measurement module, and when a result of the measurement indicates that integrity of the cryptographic operation firmware is not damaged, determining that the establishment of the dynamic measurement for trust chain is completed.

For example, in this example embodiment, the storage medium is configured to store program codes for performing the following steps: building a measurement for trust chain based on the established static measurement for trust chain and the established dynamic measurement for trust chain includes: determining that interaction between the security chip and the cryptographic operation chip is trusted; and building an intact measurement for trust chain based on the trusted interaction between the security chip and the cryptographic operation chip as well as the static measurement for trust chain and the dynamic measurement for trust chain.

The serial numbers of the example embodiments of the present disclosure are merely used for description, and do not imply the preference among the example embodiments.

In the above example embodiments of the present disclosure, the descriptions on the example embodiments have respective emphasis, and for parts that are not described in detail in an example embodiment, reference may be made to related descriptions in other example embodiments.

In several example embodiments provided in the present application, it should be understood that the disclosed technical content may be implemented in other manners. The apparatus example embodiment described above is merely schematic, for example, the division of units is merely division of logic functions, and in fact, there may be other division manners during actual implementation, for example, multiple units or components may be combined or may be integrated into another system, or some features may be ignored or not be executed. On the other hand, the displayed or discussed coupling or direct coupling or communication connection between them may be implemented by using some interfaces, and indirect coupling or communication connection between units or modules may be in an electrical form or other forms.

Units described as separated parts may be or may not be physically separated, parts displayed as units may be or may not be physical units, and they may be located at the same place, or be distributed to multiple network units. The objective of the solutions of the example embodiments may be implemented by selecting a part of or all units therein according to actual requirements.

In addition, various function units in the example embodiments of the present disclosure may be integrated into one processing unit, each unit may also exist alone physically, and two or more units may also be integrated into one unit. The integrated unit may be implemented in a form of hardware and may also be implemented in a form of a software function unit.

The integrated unit, if implemented in a form of a software functional unit and sold or used as an independent product, may be stored in a computer readable storage medium. Based on such understanding, the technical solutions of the present disclosure essentially, or the part contributing to the prior art, or all or a part of the technical solutions may be implemented in a form of a software product. The computer software product may be stored in a storage medium, and includes several instructions for instructing a computer device (which may be a personal computer, a server, a network device or the like) to execute all or a part of the steps in the methods described in the example embodiments of the present disclosure. The storage medium includes: a USB flash disk, a Read-Only Memory (ROM), a Random-Access Memory (RAM), a mobile hard disk, a magnetic disk, an optical disc, or other mediums that may store program codes.

The above descriptions are merely preferred implementation manners of the present disclosure. It should be noted that those of ordinary skill in the art may further make several improvements and modifications without departing from the principle of the present disclosure, and the improvements and modifications shall all fall within the protection scope of the present disclosure.

The present disclosure may further be understood with clauses as follows.

Clause 1. A cryptographic operation processing method, comprising:

receiving, by a cryptographic operation chip, a cryptographic operation request;

measuring, by the cryptographic operation chip, cryptographic operation algorithm firmware by using a cryptographic operation measurement root to obtain a first measurement result, and sending, by the cryptographic operation chip, the obtained first measurement result to a security chip;

receiving, by the cryptographic operation chip, a comparison result fed back by the security chip, wherein the comparison result is a result determined by the security chip and indicating whether the first measurement result is the same as a second measurement result stored in advance; and

performing, by the cryptographic operation chip, a cryptographic operation when the comparison result indicates that the first measurement result is the same as the second measurement result.

Clause 2. The method according to clause 1, wherein before the measuring, by the cryptographic operation chip, cryptographic operation algorithm firmware by using a cryptographic operation measurement root, the method further comprises:

measuring, by the cryptographic operation chip, the cryptographic operation measurement root to obtain a third measurement result; and

determining, by the cryptographic operation chip when the third measurement result is consistent with a predetermined reference value, that a measurement entity configured to execute the measurement of the cryptographic operation algorithm firmware is intact.

Clause 3. The method according to clause 1, wherein the sending, by the cryptographic operation chip, the obtained first measurement result to a security chip comprises:

encrypting, by the cryptographic operation chip, the first measurement result by using a platform cryptographic operation measurement key to obtain encrypted data; and

sending, by the cryptographic operation chip, the encrypted data to the security chip.

Clause 4. The method according to clause 3, wherein before the encrypting, by the cryptographic operation chip, the first measurement result by using a platform cryptographic operation measurement key to obtain encrypted data, the method further comprises:

decrypting, by the cryptographic operation chip, the cryptographic operation request by using a user platform identity public key to obtain a user cryptographic operation measurement key; and

generating, by the cryptographic operation chip, the platform cryptographic operation measurement key according to the user cryptographic operation measurement key and a platform measurement root.

Clause 5. The method according to clause 1, wherein the measuring, by the cryptographic operation chip, cryptographic operation algorithm firmware by using a cryptographic operation measurement root to obtain a first measurement result comprises:

performing, by the cryptographic operation chip, hash computation on a cryptographic operation algorithm in the cryptographic operation algorithm firmware by using the cryptographic operation measurement root to obtain a hash value, and using, by the cryptographic operation chip, the hash value as the first measurement result.

Clause 6. The method according to clause 5, wherein before the performing, by the cryptographic operation chip, hash computation on a cryptographic operation algorithm in the cryptographic operation algorithm firmware by using the cryptographic operation measurement root, the method further comprises:

determining, by the cryptographic operation chip, the cryptographic operation algorithm according to cryptographic operation attribute information carried in the cryptographic operation request.

Clause 7. The method according to any one of clauses 1 to 6, wherein before the measuring, by the cryptographic operation chip, cryptographic operation algorithm firmware by using a cryptographic operation measurement root, the method comprises:

verifying, by the cryptographic operation chip, validity of the cryptographic operation request according to a user platform identity certificate carried in the cryptographic operation request, and when the verification is successful, allowing the measurement of the cryptographic operation algorithm firmware.

Clause 8. A cryptographic operation processing method, comprising:

receiving, by a security chip, a first measurement result sent by a cryptographic operation chip, wherein the first measurement result is a measurement result obtained through measuring cryptographic operation algorithm firmware by the cryptographic operation chip using a cryptographic operation measurement root;

acquiring, by the security chip, a second measurement result stored in advance; and

comparing, by the security chip, the first measurement result with the second measurement result to obtain a comparison result indicating whether the first measurement result is the same as the second measurement result, and sending, by the security chip, the comparison result to the cryptographic operation chip, so that the cryptographic operation chip performs a cryptographic operation when the comparison result indicates that the first measurement result is the same as the second measurement result.

Clause 9. The method according to clause 8, wherein the receiving, by a security chip, a first measurement result sent by a cryptographic operation chip comprises:

receiving, by the security chip, encrypted data sent by the cryptographic operation chip and obtained through encrypting the first measurement result by using a platform cryptographic operation measurement key;

generating, by the security chip, the platform cryptographic operation measurement key by using a platform measurement root and a user cryptographic operation measurement key that are preset; and

decrypting, by the security chip, the encrypted data by using the generated platform cryptographic operation measurement key to obtain the first measurement result.

Clause 10. A cryptographic operation processing method, comprising:

receiving, by a cryptographic operation chip, a cryptographic operation request; measuring, by the cryptographic operation chip, cryptographic operation algorithm firmware by using a cryptographic operation measurement root to obtain a first measurement result, and sending, by the cryptographic operation chip, the obtained first measurement result to a security chip;

acquiring, by the security chip, a second measurement result stored in advance, comparing, by the security chip, whether the first measurement result is the same as the second measurement result to obtain a comparison result, and sending, by the security chip, the comparison result to the cryptographic operation chip; and performing, by the cryptographic operation chip, a cryptographic operation when the comparison result indicates that the first measurement result is the same as the second measurement result.

Clause 11. The method according to clause 10, wherein

the sending, by the cryptographic operation chip, the obtained first measurement result to a security chip comprises: encrypting, by the cryptographic operation chip, the first measurement result by using a platform cryptographic operation measurement key to obtain encrypted data; and sending, by the cryptographic operation chip, the encrypted data to the security chip; and

before the comparing, by the security chip, whether the first measurement result is the same as the second measurement result to obtain a comparison result, the method further comprises: generating, by the security chip, the platform cryptographic operation measurement key by using a platform measurement root and a user cryptographic operation measurement key that are preset; and decrypting, by the security chip, the encrypted data by using the generated platform cryptographic operation measurement key to obtain the first measurement result.

Clause 12. The method according to clause 10, wherein before the measuring, by the cryptographic operation chip, cryptographic operation algorithm firmware by using a cryptographic operation measurement root, the method comprises:

acquiring, by the cryptographic operation chip, the cryptographic operation measurement root from the security chip.

Clause 13. A method for building a measurement for trust chain, comprising:

establishing a static measurement for trust chain based on a security chip, wherein the static measurement for trust chain comprises a static measurement for trust performed on a measurement target when a system of a device is started;

establishing a dynamic measurement for trust chain based on a cryptographic operation chip, wherein the dynamic measurement for trust chain comprises a dynamic measurement for trust performed on a measurement target when a measurement for trust request is received; and building a measurement for trust chain based on the established static measurement for trust chain and the established dynamic measurement for trust chain.

Clause 14. The method according to clause 13, wherein the establishing a static measurement for trust chain based on a security chip comprises:

measuring the integrity of a basic input output system BIOS based on the security chip, and when the obtained integrity measurement result indicates that the integrity is not damaged, actively measuring at least one piece of firmware in the device based on the BIOS; and

when the integrity of one or more pieces of firmware in the device actively measured based on the BIOS is not damaged, loading the one or more pieces of firmware, and starting a system kernel of the device to complete the establishment of the static measurement for trust chain.

Clause 15. The method according to clause 13, wherein the establishing a dynamic measurement for trust chain based on a cryptographic operation chip comprises:

measuring a dynamic measurement module based on the cryptographic operation chip to obtain a measurement result, wherein the dynamic measurement module is a measurement entity configured to measure cryptographic operation firmware; and

when the measurement result indicates that integrity of the dynamic measurement module is not damaged, measuring cryptographic operation firmware and data based on the dynamic measurement module, and when a result of the measurement indicates that integrity of the cryptographic operation firmware is not damaged, determining that the establishment of the dynamic measurement for trust chain is completed.

Clause 16. The method according to clause 13 or 14, wherein the building a measurement for trust chain based on the established static measurement for trust chain and the established dynamic measurement for trust chain comprises:

determining that interaction between the security chip and the cryptographic operation chip is trusted; and

building an intact measurement for trust chain based on the trusted interaction between the security chip and the cryptographic operation chip as well as the static measurement for trust chain and the dynamic measurement for trust chain.

Clause 17. A cryptographic operation processing apparatus, applied to a cryptographic operation chip and comprising:

a first receiving module configured to receive a cryptographic operation request;

a measurement module configured to measure cryptographic operation algorithm firmware by using a cryptographic operation measurement root to obtain a first measurement result, and send the obtained first measurement result to a security chip;

a receiving module configured to receive a comparison result fed back by the security chip, wherein the comparison result is a result determined by the security chip and indicating whether the first measurement result is the same as a second measurement result stored in advance; and

an operation module configured to perform a cryptographic operation when the comparison result indicates that the first measurement result is the same as the second measurement result.

Clause 18. A cryptographic operation processing apparatus, applied to a security chip and comprising:

a second receiving module configured to receive a first measurement result sent by a cryptographic operation chip, wherein the first measurement result is a measurement result obtained through measuring cryptographic operation algorithm firmware by the cryptographic operation chip using a cryptographic operation measurement root;

an acquiring module configured to acquire a second measurement result stored in advance; and

a comparison module configured to compare the first measurement result with the second measurement result to obtain a comparison result indicating whether the first measurement result is the same as the second measurement result, and send the comparison result to the cryptographic operation chip, so that the cryptographic operation chip performs a cryptographic operation when the comparison result indicates that the first measurement result is the same as the second measurement result.

Clause 19. A cryptographic operation processing system, comprising a cryptographic operation chip and a security chip, wherein

the cryptographic operation chip is configured to receive a cryptographic operation request, measure cryptographic operation algorithm firmware by using a cryptographic operation measurement root to obtain a first measurement result, and send the obtained first measurement result to the security chip;

the security chip is configured to acquire a second measurement result stored in advance, compare whether the first measurement result is the same as the second measurement result to obtain a comparison result, and send the comparison result to the cryptographic operation chip; and

the cryptographic operation chip is further configured to perform a cryptographic operation when the comparison result indicates that the first measurement result is the same as the second measurement result.

Clause 20. A system for building a measurement for trust chain, comprising: a static measurement for trust chain building subsystem and a dynamic measurement for trust chain building subsystem, wherein

the static measurement for trust chain building subsystem is configured to establish a static measurement for trust chain based on a security chip, wherein the static measurement for trust chain comprises a static measurement for trust performed on a measurement target when a system of a device is started;

the dynamic measurement for trust chain building subsystem is configured to establish a dynamic measurement for trust chain based on a cryptographic operation chip, wherein the dynamic measurement for trust chain comprises a dynamic measurement for trust performed on a measurement target when a measurement for trust request is received; and

the static measurement for trust chain building subsystem and the dynamic measurement for trust chain building subsystem are further configured to build a measurement for trust chain based on the established static measurement for trust chain and the established dynamic measurement for trust chain.

Clause 21. A storage medium comprising a program stored therein, wherein the program, when being run, controls a device in which the storage medium resides to perform the cryptographic operation processing method according to any one of clauses 1 to 16.

Clause 22. A processor configured to run a program, wherein the program, when being run, performs the cryptographic operation processing method according to any one of clauses 1 to 16.

What is claimed is:

1. A method comprising:
receiving a cryptographic operation request;
measuring cryptographic operation algorithm firmware by using a cryptographic operation measurement root to obtain a first measurement result;
receiving a comparison result indicating that the first measurement result is the same as a second measurement result stored in advance; and
performing a cryptographic operation.

2. The method according to claim 1, wherein before the measuring the cryptographic operation algorithm firmware by using the cryptographic operation measurement root, the method further comprises:
measuring the cryptographic operation measurement root to obtain a third measurement result;
determining that the third measurement result is consistent with a predetermined reference value; and
determining that a measurement entity that executes the measurement of the cryptographic operation algorithm firmware is intact.

3. The method according to claim 1, wherein the measuring the cryptographic operation algorithm firmware is performed by a cryptographic operation chip.

4. The method according to claim 3, further comprising sending, by the cryptographic operation chip, the first measurement result to a security chip to compare the first measure result with the second measurement result.

5. The method according to claim 4, wherein the receiving the comparison result includes receiving, by the cryptographic operation chip, the comparison result fed back by the security chip.

6. The method according to claim 4, wherein the sending, by the cryptographic operation chip, the first measurement result to a security chip includes:
encrypting, by the cryptographic operation chip, the first measurement result by using a platform cryptographic operation measurement key to obtain encrypted data; and
sending, by the cryptographic operation chip, the encrypted data to the security chip.

7. The method according to claim 6, wherein before the encrypting, by the cryptographic operation chip, the first measurement result by using the platform cryptographic operation measurement key to obtain the encrypted data, the method further comprises:
decrypting, by the cryptographic operation chip, the cryptographic operation request by using a user platform identity public key to obtain a user cryptographic operation measurement key; and
generating, by the cryptographic operation chip, the platform cryptographic operation measurement key according to the user cryptographic operation measurement key and a platform measurement root.

8. The method according to claim 1, wherein the measuring the cryptographic operation algorithm firmware by using the cryptographic operation measurement root to obtain the first measurement result includes:
performing a hash computation on a cryptographic operation algorithm in the cryptographic operation algorithm firmware by using the cryptographic operation measurement root to obtain a hash value; and
using the hash value as the first measurement result.

9. The method according to claim 8, wherein before the performing the hash computation on the cryptographic operation algorithm in the cryptographic operation algorithm firmware by using the cryptographic operation measurement root, the method further comprises:
determining the cryptographic operation algorithm according to cryptographic operation attribute information carried in the cryptographic operation request.

10. The method according to claim 1, wherein before the measuring the cryptographic operation algorithm firmware by using the cryptographic operation measurement root, the method further comprises:
verifying a validity of the cryptographic operation request according to a user platform identity certificate carried in the cryptographic operation request;
determining that the verification is successful; and
allowing the measurement of the cryptographic operation algorithm firmware.

11. An apparatus comprising:
one or more processors; and
one or more memories storing computer readable instructions that, executable by the one or more processors, cause the one or more processors to perform acts comprising:
receiving a first measurement result sent by a cryptographic operation chip;
acquiring a second measurement result stored in advance; and
comparing the first measurement result with the second measurement result to obtain a comparison result that compares the first measurement result with the second measurement result; and
sending the comparison result to the cryptographic operation chip.

12. The apparatus according to claim 11, wherein the first measurement result is a measurement result obtained through measuring cryptographic operation algorithm firmware by the cryptographic operation chip using a cryptographic operation measurement root.

13. The apparatus according to claim 11, wherein the cryptographic operation chip performs a cryptographic operation in response to determining that the comparison result indicates that the first measurement result is the same as the second measurement result

14. The apparatus according to claim 11, wherein the receiving the first measurement result sent by the cryptographic operation chip comprises:
receiving encrypted data sent by the cryptographic operation chip and obtained through encrypting the first measurement result by using a platform cryptographic operation measurement key;
generating the platform cryptographic operation measurement key by using a platform measurement root and a user cryptographic operation measurement key that are preset; and
decrypting the encrypted data by using the generated platform cryptographic operation measurement key to obtain the first measurement result.

15. The apparatus according to claim 11, wherein the apparatus is a security chip.

16. One or more memories storing computer readable instructions that, executable by one or more processors, cause the one or more processors to perform acts comprising:
establishing a static measurement for trust chain based on a security chip, the static measurement for trust chain including a static measurement for trust performed on a measurement target when a system of a device is started;
establishing a dynamic measurement for trust chain based on a cryptographic operation chip, the dynamic measurement for trust chain including a dynamic measurement for trust performed on a measurement target when a measurement for trust request is received; and
building a measurement for trust chain based on the established static measurement for trust chain and the established dynamic measurement for trust chain.

17. The one or more memories according to claim 16, wherein the establishing the static measurement for trust chain based on the security chip includes:
measuring an integrity of a basic input output system BIOS based on the security chip;
determining that an obtained integrity measurement result indicates that the integrity is not damaged;
actively measuring at least one piece of firmware in the device based on the BIOS;
determining that an integrity of one or more pieces of firmware in the device actively measured based on the BIOS is not damaged;
loading the one or more pieces of firmware; and
starting a system kernel of the device to complete an establishment of the static measurement for trust chain.

18. The one or more memories according to claim 16, wherein the establishing the dynamic measurement for trust chain based on the cryptographic operation chip includes:
measuring a dynamic measurement module based on the cryptographic operation chip to obtain a measurement result, the dynamic measurement module being a measurement entity that measures cryptographic operation firmware;
determining that the measurement result indicates an integrity of the dynamic measurement module is not damaged;
measuring cryptographic operation firmware and data based on the dynamic measurement module;
determining that a result of the measurement indicates an integrity of the cryptographic operation firmware is not damaged; and
determining that an establishment of the dynamic measurement for trust chain is completed.

19. The one or more memories according to claim 13, wherein the building the measurement for trust chain based on the established static measurement for trust chain and the established dynamic measurement for trust chain includes:
determining that an interaction between the security chip and the cryptographic operation chip is trusted.

20. The one or more memories according to claim 19, wherein the building the measurement for trust chain based on the established static measurement for trust chain and the established dynamic measurement for trust chain further includes:
building an intact measurement for trust chain based on the trusted interaction between the security chip and the cryptographic operation chip and the static measurement for trust chain and the dynamic measurement for trust chain.
